(19) United States
(12) Patent Application Publication
(10) Pub. No.: US 2006/0276179 A1
(43) Pub. Date: Dec. 7, 2006

(54) Methods and systems for integrating communications services

(76) Inventors: Reza Ghaffari, Lincoln, MA (US); Afshin Moshrefi, Newburyport, MA (US); Shadman Zafar, Coppell, TX (US); Shaygan Kheradpir, New York, NY (US); Robert A. Chingon, Honolulu, HI (US); Stephen Brennan, Bedford, TX (US); Christopher L. Helbling, Stamford, CT (US); Nagendra Kunuturi, Irving, TX (US); Ravi Penumatsa, Addison, TX (US); Mahesh Rajagopalan, Irving, TX (US); Craig L. Reding, Midland Park, NJ (US); John R. Reformato, Tarry Town, NY (US); John H. Wurster, Basking Ridge, NJ (US); Sandeep Chakravarty, Irving, TX (US); Byron M. Pinto, Irving, TX (US); Alin D'Silva, Newton, MA (US); Zlauddin Majid, Irving, TX (US); Satya Raju, Flower Mound, TX (US)

Correspondence Address: VERIZON;PATENT MANAGEMENT GROUP, 1515 N. COURTHOUSE ROAD, SUITE 500, ARLINGTON, VA, 22201-2909, US

(21) Appl. No.: 10/858,973

(22) Filed: Jun. 2, 2004

Related U.S. Application Data
(63) Continuation-in-part of application No. 10/083,793, filed on Feb. 27, 2002.
(63) Continuation-in-part of application No. 10/083,792, filed on Feb. 27, 2002.
(63) Continuation-in-part of application No. 10/083,884, filed on Feb. 27, 2002.
(63) Continuation-in-part of application No. 10/083,822, filed on Feb. 27, 2002.
(63) Continuation-in-part of application No. 10/720,661, filed on Nov. 24, 2003.
(63) Continuation-in-part of application No. 10/720,859, filed on Nov. 24, 2003.
(63) Continuation-in-part of application No. 10/721,009, filed on Nov. 24, 2003.
(63) Continuation-in-part of application No. 10/720,943, filed on Nov. 24, 2003.
(63) Continuation-in-part of application No. 10/721,005, filed on Nov. 24, 2003.
(63) Continuation-in-part of application No. 10/720,868, filed on Nov. 24, 2003.
(63) Continuation-in-part of application No. 10/720,970, filed on Nov. 24, 2003.
(63) Continuation-in-part of application No. 10/720,952, filed on Nov. 24, 2003.
(63) Continuation-in-part of application No. 10/720,870, filed on Nov. 24, 2003.
(63) Continuation-in-part of application No. 10/720,633, filed on Nov. 24, 2003.
(63) Continuation-in-part of application No. 10/720,971, filed on Nov. 24, 2003.
(63) Continuation-in-part of application No. 10/720,784, filed on Nov. 24, 2003.
(63) Continuation-in-part of application No. 10/720,920, filed on Nov. 24, 2003.
(63) Continuation-in-part of application No. 10/720,825, filed on Nov. 24, 2003.
(63) Continuation-in-part of application No. 10/720,944, filed on Nov. 24, 2003.
(63) Continuation-in-part of application No. 10/720,933, filed on Nov. 24, 2003.
(63) Continuation-in-part of application No. 10/720,938, filed on Nov. 24, 2003.
(60) Provisional application No. 60/272,122, filed on Feb. 27, 2001.
(60) Provisional application No. 60/272,167, filed on Feb. 27, 2001.
(60) Provisional application No. 60/275,667, filed on Mar. 13, 2001.
(60) Provisional application No. 60/275,719, filed on Mar. 13, 2001.
(60) Provisional application No. 60/275,020, filed on Mar. 13, 2001.
(60) Provisional application No. 60/275,031, filed on Mar. 13, 2001.
(60) Provisional application No. 60/276,505, filed on Mar. 19, 2001.
(60) Provisional application No. 60/428,704, filed on Nov. 25, 2002.
(60) Provisional application No. 60/436,018, filed on Dec. 26, 2002.
(60) Provisional application No. 60/475,047, filed on Jun. 2, 2003.

(51) Int. Cl. H04Q 7/22

(52) U.S. Cl. 455/412.2

(57) ABSTRACT

Methods and systems providing access to integrated communications services are disclosed. A notification of a call to a user is received at a device associated with the user, the device being connected to a data network and including a base unit, a handset, and a user interface, wherein the device is determined based on retrieved data corresponding to the user, and the retrieved data was retrieved using information pertaining to the call. Input from the user indicative of a response to the notification is also received at the device. Response information reflective of the response to the notification is then sent to the server, wherein the server instructs a service control point to connect the call based on the response to the notification.

### RELATED APPLICATIONS

This application is a continuation-in-part of U.S. patent application Ser. No. 10/083,793, entitled “METHOD AND APPARATUS FOR CALENDARED COMMUNICATIONS FLOW CONTROL,” filed Feb. 27, 2002; U.S. patent application Ser. No. 10/083,792, entitled “VOICE MAIL INTEGRATION WITH INSTANT MESSENGER,” filed Feb. 27, 2002; U.S. patent application Ser. No. 10/083,884, entitled “DEVICE INDEPENDENT CALLER ID,” filed Feb. 27, 2002; and U.S. patent application Ser. No. 10/083,822, entitled “METHOD AND APPARATUS FOR A UNIFIED COMMUNICATION MANAGEMENT VIA INSTANT MESSAGING,” filed Feb. 27, 2002, all of which claim priority to U.S. Provisional Patent Application Nos. 60/272,122, 60/272,167, 60/275,667, 60/275,719, 60/275,020, 60/275,031, and 60/276,505, and all of which are expressly incorporated herein by reference in their entirety.

This application is also a continuation-in-part of U.S. patent application Ser. No. 10/720,661, entitled “METHODS AND SYSTEMS FOR DRAG AND DROP CONFERENCE CALLING,” filed Nov. 24, 2003; U.S. patent application Ser. No. 10/720,859, entitled “METHODS AND SYSTEMS FOR CONFERENCE CALL BUFFERING,” filed Nov. 24, 2003; U.S. patent application Ser. No. 10/721,009, entitled “METHODS AND SYSTEMS FOR COMPUTER ENHANCED CONFERENCE CALLING,” filed Nov. 24, 2003; U.S. patent application Ser. No. 10/720,943, entitled “METHODS AND SYSTEMS FOR REMOTE CALL ESTABLISHMENT,” filed Nov. 24, 2003; U.S. patent application Ser. No. 10/721,005, entitled “METHODS AND SYSTEMS FOR CALL MANAGEMENT WITH USER INTERVENTION,” filed Nov. 24, 2003; U.S. patent application Ser. No. 10/720,868, entitled “METHODS AND SYSTEMS FOR DIRECTORY INFORMATION LOOKUP,” filed Nov. 24, 2003; U.S. patent application Ser. No. 10/720,970, entitled “METHODS AND SYSTEMS FOR AUTOMATIC COMMUNICATION LINE MANAGEMENT BASED ON DEVICE LOCATION,” filed Nov. 24, 2003; U.S. patent application Ser. No. 10/720,952, entitled “METHODS AND SYSTEMS FOR ADAPTIVE MESSAGE AND CALL NOTIFICATION,” filed Nov. 24, 2003; U.S. patent application Ser. No. 10/720,870, entitled “METHODS AND SYSTEMS FOR A CALL LOG,” filed Nov. 24, 2003; U.S. patent application Ser. No. 10/720,633, entitled “METHODS AND SYSTEMS FOR AUTOMATIC FORWARDING OF COMMUNICATIONS TO A PREFERRED DEVICE,” filed Nov. 24, 2003; U.S. patent application Ser. No. 10/720,971, entitled “METHODS AND SYSTEMS FOR LINE MANAGEMENT,” filed Nov. 24, 2003; U.S. patent application Ser. No. 10/720,784, entitled “METHODS AND SYSTEMS FOR CONTACT MANAGEMENT,” filed Nov. 24, 2003; U.S. patent application Ser. No. 10/720,920, entitled “METHODS AND SYSTEMS FOR NOTIFICATION OF CALL TO PHONE DEVICE,” filed Nov. 24, 2003; U.S. patent application Ser. No. 10/720,825, entitled “METHODS AND SYSTEMS FOR SINGLE NUMBER TEXT MESSAGING,” filed Nov. 24, 2003; U.S. patent application Ser. No. 10/720,944, entitled “METHODS AND SYSTEMS FOR MULTI-USER SELECTIVE NOTIFICATION,” filed Nov. 24, 2003; U.S. patent application Ser. No. 10/720,933, entitled “METHODS AND SYSTEMS FOR CPN TRIGGERED COLLABORATION,” filed Nov. 24, 2003; and U.S. patent application Ser. No. 10/720,938, entitled “METHODS AND SYSTEMS FOR PREEMPTIVE REJECTION OF CALLS,” filed Nov. 24, 2003, all of which claim priority to U.S. Provisional Patent Application Nos. 60/428,704 and 60/436,018, and all of which are expressly incorporated herein by reference in their entirety.

Applicants also claim the right to priority under 35 U.S.C. §119(e) based on Provisional Patent Application No. 60/475,047, entitled “DC PHONE,” filed Jun. 2, 2003; and Provisional Patent Application No. 60/556,462, entitled “SYSTEMS AND METHODS FOR PROVIDING ACCESS TO INTEGRATED COMMUNICATION SERVICES,” filed Mar. 26, 2004; both of which are expressly incorporated herein by reference in their entirety.

The present application also relates to U.S. patent application Ser. No. 10/084,121, entitled “CALENDAR-BASED CALLING AGENTS,” filed Feb. 27, 2002, which is expressly incorporated herein by reference in its entirety.

### TECHNICAL FIELD

The present invention relates generally to data processing systems and, more particularly, to a method and system for integrating communication services.

### BACKGROUND

A wide variety of devices exist for communication between users. For example, a single user may have a home phone, work phone, and mobile phone. In addition, the user may also have devices such as PC's, PDA's, pagers, etc. A wide variety of services exist through each of these devices.

There are numerous Internet related services that a user may want to perform that are each related to a separate device. A user may want to access the news, weather, or stocks using a PC on a broadband connection, or send text message using a cell phone. A user may also wish to surf the web using a PDA or send email using the PDA, PC, or cell phone. Users may also have a calendar set up at work and therefore when they are at home, they are unable to view it, as well as other devices that are specifically related to their work.

Additionally, there are numerous call management services that a user might want to perform that may also each be related to a different device possibly at a different location. For example, a user may wish to treat a phone call differently dependent on who is calling the user. More particularly, if a user receives a call from a caller that the user does not want to speak to at the moment, the user may want to send that call directly to voice mail.

Unfortunately, managing such a wide variety of communication devices can be difficult as well as cumbersome. Typically, to implement communication management, a person must individually manage each communication device separately. Thus, when the user wishes to change how communication is managed, the user may have to deal with numerous devices and, perhaps, service centers. Also, depending on where the user is, whether at home, work, or on the road, he or she may not have access to the devices that are only associated with the home, or work, and as a result, he or she may miss important phone calls, emails, and other messages relating to each device.

Accordingly, there is a need for a method and system for converging data services with telephony services all in one unit so as to allow the user to have one central location where they can perform call management functions as well as performing various Internet and telephony related services.

### SUMMARY OF THE INVENTION

Methods and systems consistent with the principles of the invention provide access to integrated communications services. A notification of incoming data is received at a preferred device of a user from a server, wherein the server receives information indicating incoming data directed to one of a plurality of devices of the user other than the preferred device, and sends the notification to the preferred device, the data being in the form of one of a plurality of data types, and the notification including an identification of the type of incoming data. The notification is displayed at the preferred device, wherein the preferred device is determined based on retrieved at a corresponding to the user, is connected to a data network, and includes a base unit, a handset, and a user interface.

Other methods and systems consistent with the principles of the invention also provide access to integrated communications services in a communications network. Input from a user reflective of line management information regarding two or more communications lines associated with an account for the user is received at a device. The line management information, is sent from the device, to a server over a data network, wherein the server determines that the line management information includes a modification to at least one of the communications lines associated with the account, and transmits an instruction to a component of the communications network to implement the modification to the at least one communications line, wherein the device is connected to the data network, and includes a base unit, a handset, and a user interface.

Other methods and systems consistent with the principles of the invention also provide providing access to integrated communications services. Notification of a call to a user at a device associated with the user is received, the device being connected to a data network and including a base unit, a handset, and a user interface, wherein the device is determined based on retrieved data corresponding to the user, and the retrieved data was retrieved using information pertaining to the call. Input from the user indicative of a response to the notification is received at the device. Response information reflective of the response to the notification is sent to a server, wherein the server instructs a service control point to connect the call based on the response to the notification.

Other methods and systems consistent with the principles of the invention also provide access to integrated communications services. Audio is captured contemporaneously with video at a first telephone. The captured audio is transmitted, via a circuit-switched connection, from the first telephone to a second telephone. The captured video is transmitted, via a packet-switched connection, from the first telephone to the second telephone.

### BRIEF DESCRIPTION OF THE DRAWINGS

The accompanying drawings, which are incorporated in and constitute a part of this specification, illustrate one embodiment of the invention and, together with the description, serve to explain the principles of the invention.

FIG. 1 is a diagram of an exemplary data processing and telecommunications environment in which features and aspects consistent with the principals of the present invention may be implemented;

FIG. 2 is a diagram of an exemplary user terminal, consistent with the principals of the present invention;

FIG. 3 is a diagram of a voice network, consistent with the principles of the present invention;

FIG. 4 is a block diagram of a service center, consistent with the principles of the present invention;

FIG. 5 illustrates a logical architecture of an exemplary system, consistent with the present invention;

FIG. 6 is another diagram of an exemplary user terminal, consistent with the principals of present invention.

FIG. 7 illustrates exemplary features of a user terminal, consistent with the present invention;

FIG. 8 illustrates an exemplary handset of a user terminal consistent with the present invention;

FIG. 9 illustrates an exemplary call log, consistent with the present invention;

FIG. 10 illustrates an exemplary voice mail list, consistent with the present invention;

FIG. 11 illustrates an exemplary list of geographic locations associated with registered phones;

FIG. 12 is a diagram of an exemplary flow chart of a method for providing a call notification over a voice and data network consistent with the present invention;

FIG. 13 is a diagram of an exemplary flowchart of a method for providing a voice mail notification over a voice and data network consistent with the present invention;

FIG. 14 is a diagram of an exemplary flowchart of a method for implementing user's selections, consistent with the present invention;

FIG. 15 is a diagram of an exemplary flowchart of a method for call forwarding by an SSP updated via a CFV update, consistent with the present invention;

FIG. 16 is a diagram of an exemplary flowchart of a method for call forwarding, for an SSP providing AIN services, consistent with the present invention;

FIG. 17 illustrates a flow chart of a method for forwarding calls based on the caller-ID of the call consistent with the present invention;

FIG. 18 shows an exemplary network access server consistent with the present invention;

FIG. 19 shows an exemplary application server consistent with the present invention;

FIG. 20 is a diagram of an exemplary flowchart of a method for real-time call management in a manner consistent with the present invention;

FIGS. 21A and 21B comprise an expanded diagram of an exemplary flowchart of a method for real-time call management in a manner consistent with the present invention;

FIG. 22 is a diagram of an exemplary user interface including customer-selectable real-time call management options;

FIG. 23 is a diagram of an exemplary user interface that enables a customer to change preferences consistent with the present invention;

FIGS. 24-26 are flowcharts that illustrate an exemplary process for setting up an audio and video connection between two callers consistent with principles of the present invention; and

FIG. 27 illustrates an exemplary graphical user interface for sending and receiving video via a packet-switched connection at a digital companion phone consistent with the present invention.

### DETAILED DESCRIPTION

Reference will now be made in detail to exemplary embodiments of the present invention, examples of which are illustrated in the accompanying drawings. Wherever possible, the same reference numbers will be used throughout the drawings to refer to the same or like parts. While the description includes exemplary embodiments, other embodiments are possible, and changes may be made to the embodiments described without departing from the spirit and scope of the invention. The following detailed description does not limit the invention. Instead, the scope of the invention is defined by the appended claims and their equivalents.

### Network Environment

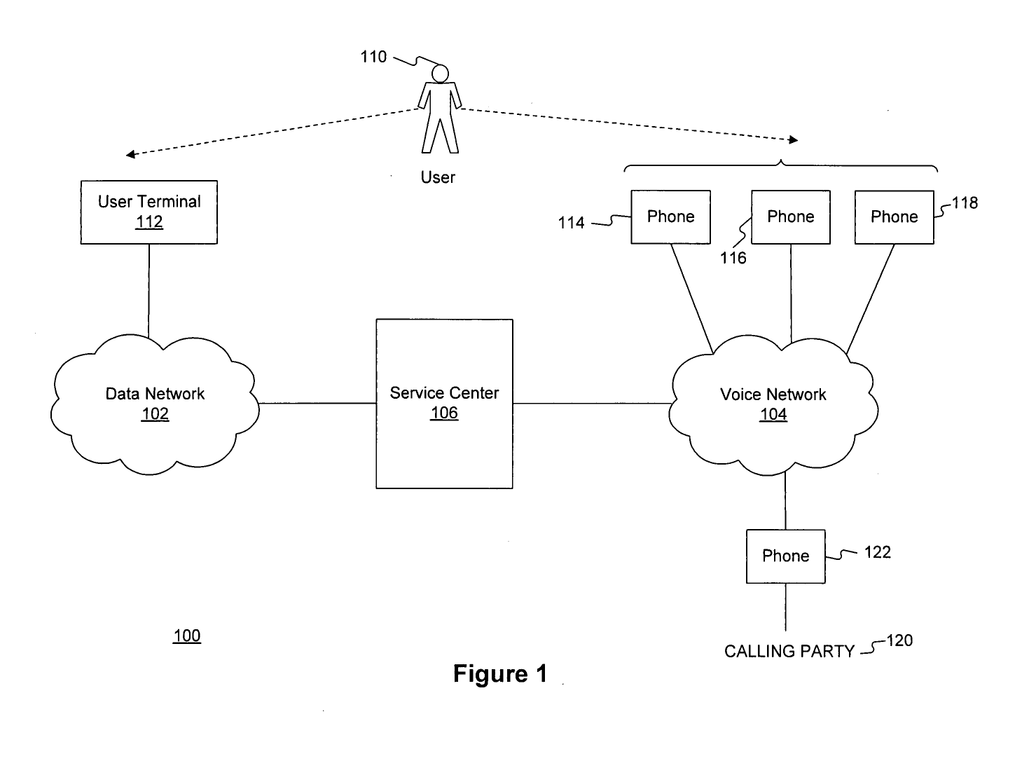

FIG. 1 is a block diagram of a data processing and telecommunications environment 100, in which features and aspects consistent with the present invention may be implemented. The number of components in environment 100 is not limited to what is shown and other variations in the number of arrangements of components are possible, consistent with embodiments of the invention. The components of FIG. 1 may be implemented through hardware, software, and/or firmware. Data processing and telecommunications environment 100 may include a data network 102, a voice network 104, and a service center 106. A user 110 may use a user terminal 112 to interface with data network 102 and may use phones 114, 116, and 118 to interface with voice network 104. Calling party 120 may use phone 122 to call a user, such as user 110, at any one of phones 114, 116, and 118.

Data network 102 provides communications between the various entities depicted in environment 100 of FIG. 1, such as user terminal 112 and service center 106. Data network 102 may be a shared, public, or private network and encompass a wide area or local area. Data network 102 may be implemented through any suitable combination of wired and/or wireless communication networks. By way of example, data network 102 may be implemented through a wide area network (WAN), local area network (LAN), an intranet and/or the Internet. Further, the service center 106 may be connected to multiple data networks 102, such as, for example, to a wireless carrier network and to the Internet.

Voice network 104 may provide telephony services to allow a calling party, such as calling party 120, to place a telephone call to user 110. In one embodiment, voice network 104 may be implemented using a network, such as the Public Switched Telephone Network (“PSTN”). Alternatively, voice network 104 may be implemented on a voice over broadband network, such as a network using voice-over Internet Protocol (“VoIP”) technology. Additionally, in other embodiments, the voice network may be a video over broadband network, such as, for example, a network for providing 2-way video communications. In another example, the voice network may be a wireless broadband network, such as, for example, a network using WiFi (i.e., IEEE 802.11 (b) and/or (g)). In yet another example, the voice network 104 may be a wireless voice network(s), such as, for example, a cellular or third-generation cellular network). In addition, voice network 104 may be implemented using any single or combination of the above-described technologies consistent with the principles of the present invention. Further, service center 106 may be connected to multiple voice networks 104, such as for example, Verizon's ™ Voice Network, voice networks operated by other carriers, and wireless carrier networks.

Service center 106 provides a platform for managing communications over data network 102 and voice network 104. Service center 106 also provides gateway functions, such as code and protocol conversions, to transfer communications between data network 102 and voice network 104. Service center 106 may be implemented using a combination of hardware, software, and/or firmware. For example, service center 106 may be implemented using a plurality of general purpose computers or servers coupled by a network (not shown). Although service center 106 is shown with direct connections to data network 102 and voice network 104, any number and type of network elements may be interposed between service center 106, data network 102, and voice network 104.

User terminal 112 provides user 110 an interface to data network 102. For example, user terminal 112 may be implemented using any device capable of accessing the Internet, such as a general purpose computer or personal computer equipped with a modem. User terminal 112 may also be implemented in other devices, such as the Blackberry™, and Ergo Audrey™. Furthermore, user terminal 112 may be implemented in wireless devices, such as pagers, mobile phones (with data access functions), and Personal Digital Assistants (“PDA”) with network connections. In one embodiment, a user terminal 112 may be implemented using a device with connections to both data network 102 and voice network 104.

User terminal 112 also allows user 110 to communicate with service center 106. For example, user 110 may use instant messaging (“IM”) to communicate with service center 106. In addition, user terminal 112 may use other aspects of TCP/IP including the hypertext transfer protocol (“HTTP”); the user datagram protocol (“UDP”); the file transfer protocol (“FTP”); the hypertext markup language (“HTML”); and the extensible markup language (“XML”).

Furthermore, user terminal 112 may communicate directly with service center 106. For example, a client application may be installed on user terminal 112, which directly communicates with service center 106. Also, user terminal 112 may communicate with service center 106 via a proxy.

Phones 114, 116, 118, and 122 interface with voice network 104. Phones 114, 116, 118, and 122 may be implemented using known devices, including wireline phones and mobile phones. Although phones 114, 116, 118, and 122 are shown directly connected to voice network 104, any number of intervening elements, such as a private branch exchange (“PBX”), may be interposed between phones 114, 116, 118, and 122 and voice network 104.

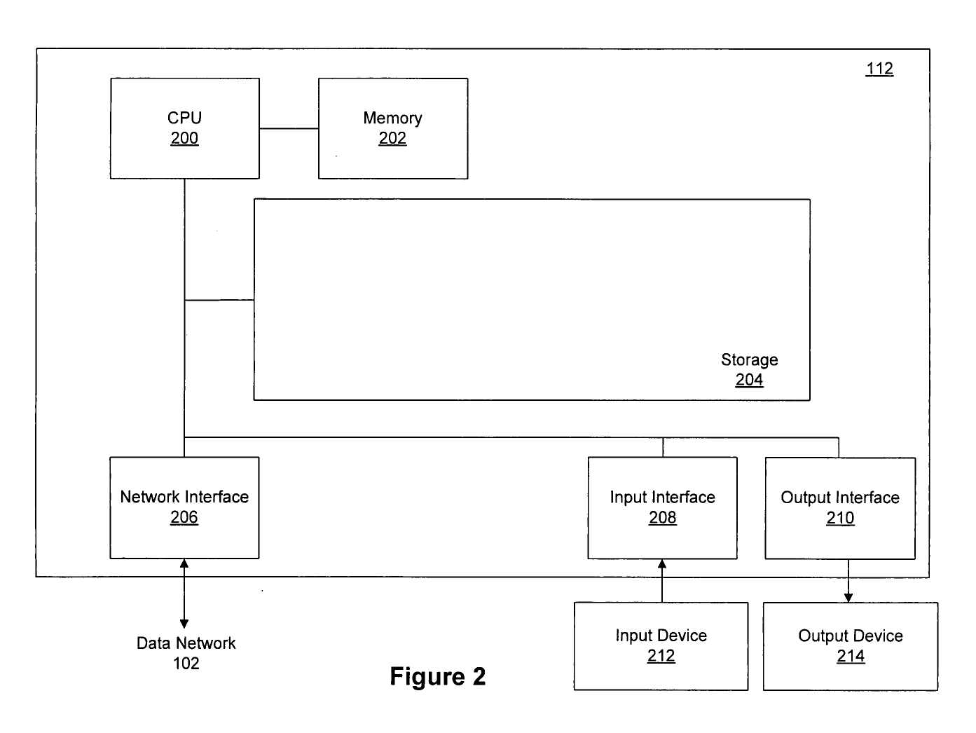

FIG. 2 is a block diagram of a user terminal consistent with the present invention. User terminal 112 may include a central processing unit (CPU) 200, a memory 202, a storage module 204, a network interface 206, an input interface 208, an output interface 210, an input device 216, and an output device 218.

CPU 200 provides control and processing functions for user terminal 112. Although FIG. 2 illustrates a single CPU, user terminal 112 may include multiple CPUs. CPU 200 may also include, for example, one or more of the following: a co-processor, memory, registers, and other processing devices and systems as appropriate. CPU 200 may be implemented, for example, using a Pentium™ processor provided from Intel Corporation.

Memory 202 provides a primary memory for CPU 200, such as for program code. Memory 202 may be embodied with a variety of components of subsystems, including a random access memory (“RAM”) and a read-only memory (“ROM”). When user terminal 112 executes an application installed in storage module 204, CPU 200 may download at least a portion of the program code from storage module 204 into memory 202. As CPU 200 executes the program code, CPU 200 may also retrieve additional portions of program code from storage module 204.

Storage module 204 may provide mass storage for user terminal 112. Storage module 204 may be implemented with a variety of components or subsystems including, for example, a hard drive, an optical drive, CD ROM drive, DVD drive, a general-purpose storage device, a removable storage device, and/or other devices capable of storing information. Further, although storage module 204 is shown within user terminal 112, storage module 204 may be implemented external to user terminal 112.

Storage module 204 includes program code and information for user terminal 112 to communicate with service center 106. Storage module 204 may include, for example, program code for a calendar application, such as GroupWise provided by Novell Corporation or Outlook provided by Microsoft Corporation; a client application, such as a Microsoft Network Messenger Service (MSNMS) client or America Online Instant Messenger (AIM) client; and an Operating System (OS), such as the Windows Operation System provided by Microsoft Corporation. In addition, storage module 204 may include other program code and information, such as program code for TCP/IP communications; kernel and device drivers; configuration information, such as a Dynamic Host Configuration Protocol (DHCP) configuration; a web browser, such as Internet Explorer provided by Microsoft Corporation, or Netscape Communicator provided by Netscape Corporation; and any other software that may be installed on user terminal 112.

Network interface 206 provides a communications interface between user terminal 112 and data network 102. Network interface 206 may receive and transmit communications for user terminal 112. For example, network interface 206 may be a modem, or a local area network (“LAN”) port.

Input interface 208 receives input from user 110 via input device 212 and provides the input to CPU 200. Input device 212 may include, for example, a keyboard, a microphone, graphical user interface, and/or a mouse. Other types of input devices may also be implemented consistent with the principles of the present invention.

Output interface 210 provides information to user 110 via output device 214. Output device 214 may include, for example, a display, (including a touchscreen or per-based LCD display, or other type of display), a printer, and/or a speaker. Other types of output devices may also be implemented consistent with the principles of the present invention.

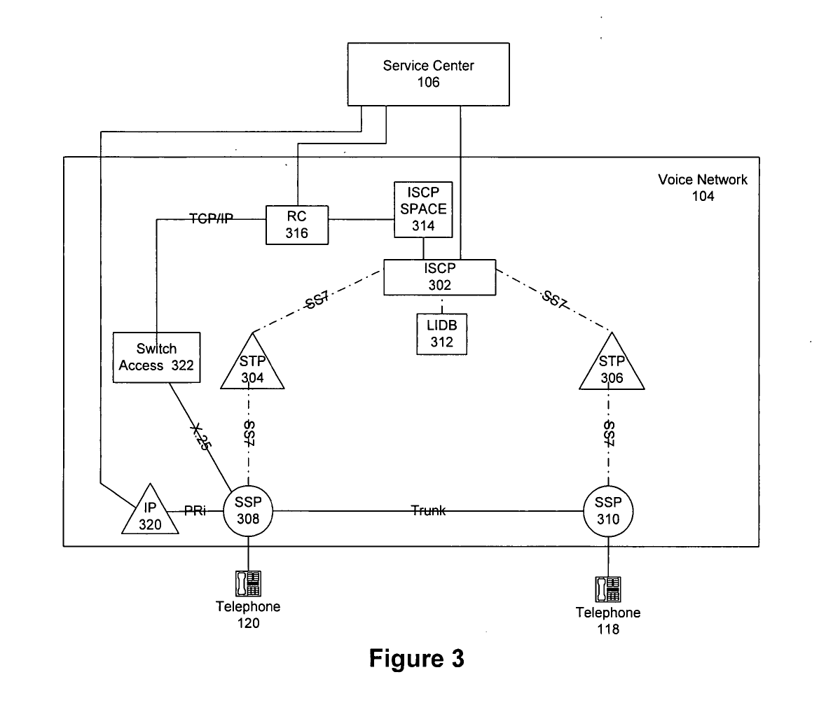

FIG. 3 is a diagram of a voice network, consistent with the principles of the present invention. As shown, voice network 104 includes an intelligent service control point (ISCP) 302, service transfer points (STP) 304 and 306, service switching points (SSP) 308 and 310, a line information database (LIDB) 312, an ISCP Service Provisioning And Creation Environment (SPACE) 314, a Recent Change Environment 316, an Intelligent Peripheral (IP) 320, and a switch access 322. Although this embodiment of a voice network 104 is described as a PSTN, as discussed above in other embodiments, the voice network 104 may be, for example, a voice or video over broadband network, a wireless broadband, a wireless voice network, etc.

Voice network 104 may be implemented using the PSTN and SS7 as a signaling protocol. The SS7 protocol allows voice network 104 to provide features, such as call forwarding, caller-ID, three-way calling, wireless services such as roaming and mobile subscriber authentication, local number portability, and toll-free/toll services. The SS7 protocol provides various types of messages to support the features of voice network 104. For example, these SS7 messages may include Transaction Capabilities Applications Part (“TCAP”) messages to support event “triggers,” and queries and responses between ISCP 302 and SSPs 308 and 310.

ISCP 302 may also be, for example, a standard service control point (SCP), an Advanced Intelligent Network (AIN) SCP, a soft switch, or any other network call controller. ISCP 302 provides translation and routing services of SS7 messages to support the features of voice network 104, such as call forwarding. In addition, ISCP 302 may exchange information with the service center 106 using TCP/IP or SS7. ISCP 302 may include service logic used to provide a switch, such as SSP 308 or 310, with specific call processing instructions. ISCP 302 may also store data related to various features that a user may activate. Such features may include, for example, call intercept and voice mail. ISCP 302 may be implemented using a combination of known hardware and software. ISCP 302 is shown with a direct connection to service center 106 and a connection to ISCP SPACE 314, however, any number of network elements including routers, switches, hubs, etc., may be used to connect ISCP 302, ISCP SPACE 314, and service center 106. Further, information exchanged between the ISCP 302 and service center 106 may use, for example, the SR-3389 General Data Interface (GDI) for TCP/IP.

STPs 304 and 306 relay SS7 messages within voice network 104. For example, STP 304 may route SS7 messages between SSPs 308 and 310. STP 304 or 306 may be implemented using known hardware and software from manufacturers such as NORTEL™ and LUCENT Technologies™.

SSPs 308 and 310 provide an interface between voice network 104 and phones 114 and 120, respectively, to setup, manage, and release telephone calls within voice network 104. SSPs 308 and 310 may be implemented as a voice switch, an SS7 switch, or a computer connected to a switch. SSPs 308 and 310 exchange SS7 signal units to support a telephone call between calling party 120 and user 110. For example, SSPs 308 and 310 may exchange SS7 messages, such as TCAP messages, within message signal units (“MSU”) to control calls, perform database queries to configuration database 312, and provide maintenance information.

Line Information Database (LIDB) 312 comprises one or more known databases to support the features of voice network 104. For example, LIDB 312 may include subscriber information, such as a service profile, name and address, and credit card validation information. Although, in this figure, LIDB 312 is illustrated as directly connected to ISCP 302, LIDB 312 may be connected to ISCP 302 through an STP (e.g., 304 and 306). Additionally, this communication link may use, for example, the GR-2838 General Dynamic Interface (GDI) for SS7.

ISCP Service Provisioning and Creation Environment (SPACE) 314 may be included as part of the ISCP 302 or be separate from the ISCP 302. For example, the Telcordia™ ISCP may include an environment similar to SPACE 314 as part of the product. Further, ISCP SPACE 314 may include one or more servers. ISCP SPACE 314 is the point in the ISCP platform where customer record updates may be made.

In one embodiment, customer records may be stored in the ISCP SPACE 314 such that the records may be updated and sent to the ISCP 302. These records may include information regarding how to handle calls directed to the customer. For example, these customer records may include information regarding whether or not calls for the customer are to be forwarded to a different number, and/or whether or not the call should be directed to an IP, such as a voice mail system, after a certain number of rings. Additionally, one ISCP SPACE 314 may provide updates to one or more ISCPs 302 via an ISCP network (not shown).

Additionally, the voice network 104 may include one or more recent change engines 316 such as, for example, an Enterprise Recent Change engine (eRC); an Assignment, Activation, and Inventory System (AAIS); or a multi-services platform (MSP). As an example, the eRC and AAIS may be used in voice networks 104 located in the western part of the United States, while an MSP may be used in networks in the eastern part. The recent change engines may be used to update switch and ISCP databases. For example, a recent change engine may deliver database updates to SSPs and to ISCPs, such that when updating databases, these recent change engines emulate human operators. Additionally, if the instructions are to be sent to an ISCP 302, the recent change engine may first send the instructions to the ISCP SPACE 314, which then propagates the instructions to the ISCP 302 as discussed above. Further, an MSP or eRC may be used, for example, for providing updates to both the SSPs 308 or 310 and the ISCPs 302. Or, for example, an eRC may be used for providing updates to the SSPs 308 or 310, while an AAIS is used for providing updates to the ISCPs 302.

Updates sent to the SSPs 308 or 310 may be sent from the recent change engine 316 via a switch access 322 that may, for example, convert the updates into the appropriate protocol for the SSP 308 or 310. For example, recent change engine 316 may send updates to the SSPs 308 or 310 via TCP/IP. The switch access 322 may then convert the updates from TCP/IP to X.25. This switch access 322 may be implemented using hardware and/or software. These connections may include any number of elements, such as, for example, switches, routers, hubs, etc. and may be, for example, an internal data network for the voice network 104.

The voice network 104 may also include one or more intelligent peripherals (IP). For example, in FIG. 3, an IP 320 is illustrated as being connected to SSP 308. These IPs may be used for providing functions for interaction between users and the voice network, such as voice mail services, digit collection, customized announcements, voice recognition, etc. Moreover, the communications between the SSP 308 and IP 320 may use the Primary Rate interface (PRi) (e.g., the 1129 protocol) protocol. Additionally, the IP 320 may be capable of sending and receiving information to/from the Service Center 106. These communications may use, for example, the SR-3511 protocol. Further, although FIG. 3 illustrates this connection as a direct connection, this connection may include any number of elements including routers, switches, hubs, etc., and may be via, for example, an internal data network for the voice network 104.

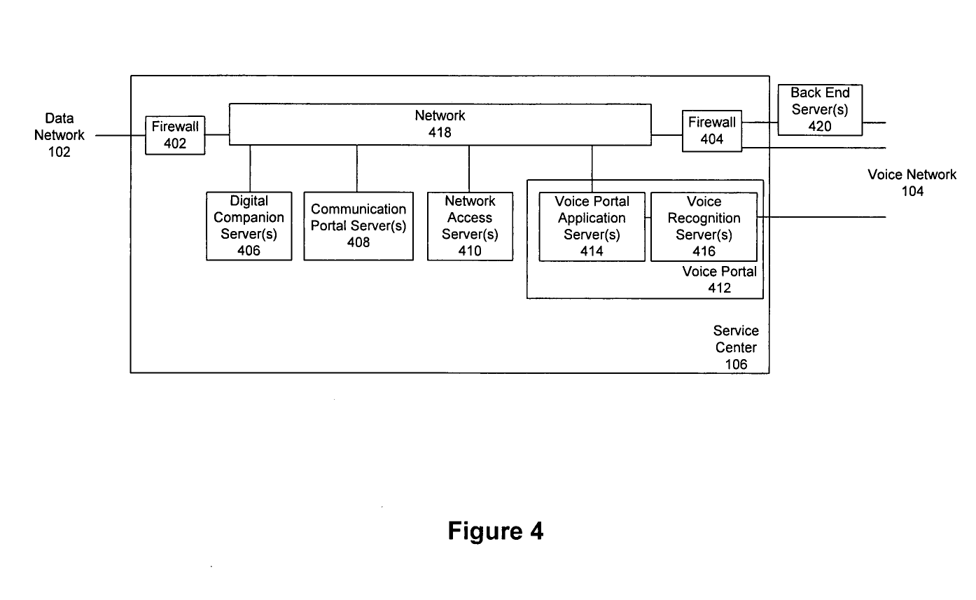

FIG. 4 is a block diagram of a service center, consistent with the principles of the present invention. As shown, service center 106 may include firewalls 402 and 404, one or more digital companion servers 406, one or more communication portal servers 408, one or more network access servers 410, and a voice portal 412. The voice portal 412 may include a voice portal application server 414 and a voice recognition server 416. A network 418 may be used to interconnect the firewalls and servers. Additionally, back end server(s) 420 may be provided between the service center 106 and the voice network 104.

Firewalls 402 and 404 provide security services for communications between service center 106, data network 102, and voice network 104, respectively. For example, firewalls 402 and 404 may restrict communications between user terminal 112 and one or more servers within service center 106. Any appropriate security policy may be implemented in firewalls 402 and 404 consistent with the principles of the present invention. Firewalls 402 and 404 may be implemented using a combination of known hardware and software, such as the Raptor Firewall provided by the Axent Corporation. Further, firewalls 402 and 404 may be implemented as separate machines within service center 106, or implemented on one or more machines external to service center 106.

Network 418 may be any type of network, such as an Ethernet or FDDI network. Additionally, network 418 may also include switches and routers as appropriate without departing from the scope of the invention. Further, additional firewalls may be present in the network 418, for example, to place one or more of servers 406, 408, 410, or voice portal 412 behind additional firewalls.

Each server (406, 408, 410, 414, 416, 420) may be any appropriate type of server or computer, such as a Unix or DOS-based server or computer. The servers may implement various logical functions, such as those described below. In FIG. 4, a different server is illustrated as being used for each logical function. In other embodiments, the logical functions may be split across multiple servers, multiple servers may be used to implement a single function, all functions may be performed by a single server, etc.

In general, a digital companion server 406 may provide the software and hardware for providing specific services of the service center. Exemplary services include, for example, permitting a customer to add contacts to their address book from a history of calls made or received by the customer, permitting a customer to make calls directly from their address book, scheduling a call to be placed at a specific time, or permitting the customer to look at the name and/or address associated with a phone number. Additionally, these services may include permitting the customer to listen to their voice mail on-line, forwarding their calls based on a scheduler and/or the calling parties number, setting up conference calls on-line, real-time call management, etc. In one embodiment, real-time call management enables a user to perform several functions as a call is being received, such as sending a call to voice mail, sending a call received on one device to another device, manually initiating protection from telemarketers, playing an announcement for the caller, scheduling a call back, bridging a caller onto a current call, etc.

A communication portal server 408 may provide the hardware and software for managing a customer's account and interfacing with customer account information stored by the provider of customer's voice network 104. The network access servers 410 may provide the hardware and software for sending and receiving information to the voice network 104 in processing the applications provided by the service center. For example, the network access servers 410 may be used for transmitting and/or receiving information from/to an ISCP 302 or an SSP 308 or 310 of the voice network 104.

The voice portal 412 includes software and hardware for receiving and processing instructions from a customer via voice. For example, a customer may dial a specific number for the voice portal 412. Then the customer using speech may instruct the service center 105 to modify the services to which the customer subscribes. The voice portal 412 may include, for example, a voice recognition function 416 and an application function 414. The voice recognition function 416 may receive and interpret dictation, or recognize spoken commands. The application function 414 may take, for example, the output from the voice recognition function 416, convert it to a format suitable for the service center 106 and forward the information to one or more servers (406, 408, 410) in the service center 106.

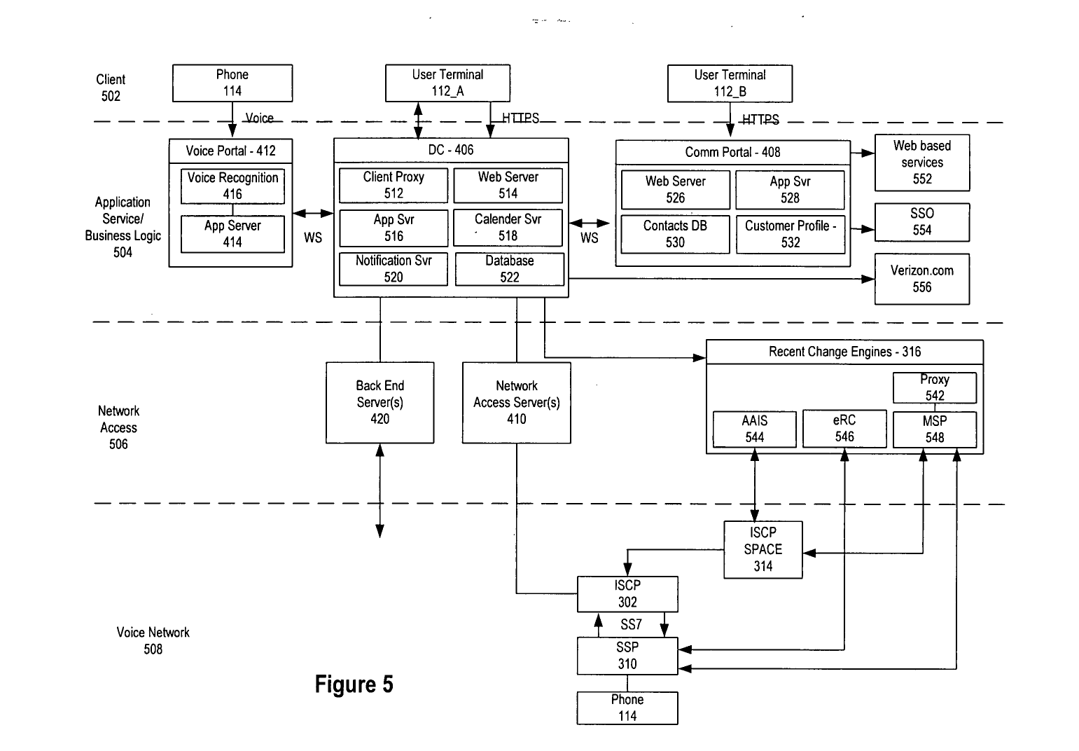

FIG. 5 illustrates a logical architecture of an exemplary system, consistent with the present invention. As illustrated, the logical architecture may be split into four planes: client side 502, application service 504, network access 506, and the voice network 508.

Client side 502 includes user terminals 112_A and 112_B that a user may use to send and/or receive information to/from the service center 106. Additionally, client side 502 includes the user's phone(s) 114. As discussed above, user terminals 112 may be any type of device a user may use for communicating with Service Center 106. For example, user terminal 112_A may be a PDA running a program for communicating with the Service Center 106, while user terminal 112_B may be a desktop type computer running a web browser for communicating with the Service Center 106 via the Internet. Additionally, the user may have one or more phones 114, such as, for example, one or more standard landline telephones and/or wireless phones.

The application service plane 504 includes the digital companion server(s) 406, communication portal server(s) 408, and the voice portal 412. These entities may communicate between one another using, for example, web services or any other suitable protocols. Web services are a standardized way of integrating Web-based applications using the Extensible Markup Language (XML), Simple Object Access Protocol (SOAP), Web Services Description Language (WSDL) and Universal Description, Discovery and Integration (UDDI) open standards over an Internet protocol (IP) backbone.

As illustrated, a digital companion server 406 may provide the following functions: a client proxy 512, a web server 514, an application server function 516, a calendar server function 518, a notification server function 520, and a database function 522. Each of these functions may be performed in hardware, software, and/or firmware. Further, these functions may each be executed by a separate server, split across multiple servers, included on the same server functions, or any other manner.

The client proxy function 512 provides a proxy function for the digital companion that may be used for security purposes. This client proxy function 512 may be included in a separate server such that all communications sent from the other digital companion functions/servers to a user terminal 112 via the data network 102 go through the client proxy 512. Also, if the client proxy 512 is included on a separate server, for example, an additional firewall may be provided between the client proxy 512 and the other digital companion servers to provide additional security.

Web server 514 provides functionality for receiving traffic over the data network 102 from a customer. For example, web server 514 may be a standard web server that a customer may access using a web browser program, such as Internet Explorer or Netscape Communicator.

Application server function 516 encompasses the general functions performed by the digital companion server(s) 406. For example, these functions may include interfacing with the various other digital companion functions to perform specific services provided by the service center. These services may include, for example, interfacing with other function(s), software, and/or hardware to provide a customer with the capability of managing their calls online. For example, permitting a customer to add contacts to their address book from a history of calls made or received by the customer, permitting a customer to make calls directly from their address book, scheduling a call to be placed at a specific time, or permitting the customer to look at the name and/or address associated with a phone number. Additionally, these services may include permitting the customer to listen to their voice mail on-line, forwarding their calls based on a scheduler and/or the calling parties number, setting up conference calls on-line, enabling call management with user intervention in real-time, etc.

Additionally, the application server function 516 may interface with one or more external devices, such as an external web server, for retrieving or sending information. For example, the application server function 516 may interface with a voice network's data center 556 (e.g., verizon.com) to determine the services to which the customer subscribes (e.g., call waiting, call forwarding, voice mail, etc.).

Calendar server function 518 may provide the capability of scheduling events, logging when certain events occurred, triggering the application-functions to perform a function at a particular time, etc.

Notification server function 520 provides the capability to send information from the service center 106 to a user terminal 112. For example, the notification server function 520 at the direction of the application server function 516 may send a notification to the user terminal 112 that the user is presently receiving a phone call at the user's phone 114. This notification may be, for example, an instant message pop-up window that provides an identification of the caller as well as the number being called. The notification may also have a number of user-selectable buttons or items associated with it that enable the user to manage a call in real-time.

Database function 522 provides the storage of information useable by the various applications executed by the digital companion servers. These databases may be included in, for example, one or more external storage devices connected to the digital companion servers. Alternatively, the databases may be included in storage devices within the digital companion servers themselves. The storage devices providing the database function 522 may be any type of storage device, such as for example, CD-ROMs, DVD's, disk drives, magnetic tape, etc.

As discussed above, the communication portal server(s) 408 provide the hardware and software for managing a customer's account and interfacing with customer account information stored by the provider of customer's voice network 104. As illustrated in FIG. 5, a communication portal server 408 may provide the following functions: a web server function 526, an application server function 528, a contacts database function 530, and/or a customer profile function 532. Each of these functions may be performed by a separate server, split across multiple servers, included on the same server functions, or any other manner.

Web server function 526, as with web server function 514 of the digital companion servers, provides functionality for receiving traffic over the data network 102 from a customer. For example, the web server may be a standard web server that a customer may access using a web browser, such as Internet Explorer or Netscape Communicator.

The application server function 528 encompasses the general functions performed by the communication portal servers 408. For example, these functions may include interfacing with the voice network to retrieve and/or modify customer profile information, and creating and editing an address book for the user. Additionally, the application server function 528 may include the functionality of sending and/or receiving information to/from external servers and/or devices. For example, the communication portal servers 408 may be connected to a network, such as, the Internet. The application server function 528 may then provide connectivity over the Internet to external servers 552 that provide web services, such as the Superpages web page. The application server function 528 could then contact these external services 552 to retrieve information, such as an address for a person in the user's address book.

In another example, the application server function 528 of the communication portal 408 may interface a single sign on (SSO) server 554. SSO 554 may be used to allow users to access all services to which the user subscribes, on the basis of a single authentication that is performed when they initially access the network.

Moreover, the application server function 528, similar to application server 516, may provide functionality to facilitate services performed by the service center. These services may include, for example, interfacing with other function(s), software, and/or hardware to provide a customer with the capability of managing their calls online. For example, permitting a customer to add contacts to their address book from a history of calls made or received by the customer, permitting a customer to make calls directly from their address book, scheduling a call to be placed at a specific time, or permitting the customer to look at the name and/or address associated with a phone number. Additionally, these services may include permitting the customer to listen to their voice mail on-line, forwarding their calls based on a scheduler and/or the calling parties number, setting up conference calls on-line, enabling call management with user intervention in real-time, etc.

The contacts database 530 includes storage devices for storing an address book for the user. This address book may be any appropriate type of address book. For example, the user's address book may include the names, phone numbers, and addresses of people and/or organizations. These storage devices may be internal or external to the communication portal servers 406 or some combination in between. In addition, these storage devices may be any type of storage device, such as magnetic storage, memory storage, etc.

The customer profile database 532 includes storage devices for storing customer profile information for the user. These storage devices may be the same or separate storage devices used for the contacts database. The customer profile may include information regarding the user's account for their voice network. For example, this information may include the user's name, billing address, and other account information. Additionally, the customer profile may include information regarding voice services to which the user subscribes, such as, for example, call waiting, voice mail, etc.

The application services plane 504 of the architecture may also include a voice portal 412. As discussed above, the voice portal 412 may include, for example, a voice recognition function 416 and an application server function 414, and be used for receiving and processing instructions from a customer via voice. The voice recognition function may be implemented using hardware and/or software capable of providing voice recognition capabilities. This hardware and/or software may be a commercially available product, such as the Voice Application platform available from Tellme Networks, Incorporated. The application server function 414 of the voice portal 412 may include hardware and/or software for exchanging information between the digital companion servers 406 and the voice recognition function 416. Additionally, the application server function 414 may be included on a separate server, included in the hardware and software providing the voice recognition function 416, included in the digital companion servers 406, etc.

The Network Access plane 506 of the architecture includes the functions for providing connectivity between the application service plane 502 and the voice network 104. For example, this plane may include the recent change engines 316, network access servers 410, and/or back end servers 420.

As discussed above, recent change engines 316 may be used to update switches and ISCP databases included in the voice network 104. In one embodiment, the recent change engines 316 may include an AAIS 544, an eRC 546, and/or an MSP 548. Additionally, a proxy 542 may be used between the digital companion servers 406 and the recent change engines 542 for security purposes.

The network access servers 410 may be included in the service center 106 and may provide the hardware and software for sending and receiving information to the voice network 410 in processing the applications provided by the service center. For example, the network access servers 410 may include a Caller ID (CID) functionality for retrieving caller ID information from the voice network 104, a click to dial (CTD) functionality for instructing an intelligent peripheral (IP) in the voice network to place a call via an SSP, and/or a real time call management (RTCM) functionality for interfacing with an ISCP of the voice network.

Network Access plane 506 may also include one or more back end server(s) 420. These back end server(s) 420 may include hardware and/or software for interfacing the service center 106 and the voice network 104. The back end server(s) 420 may be connected to the service center 106 by a network, by a direct connection, or in any other suitable manner. Further, the back end server(s) 420 may connect to one or more devices in the voice network 104 by a network, a direct connection, or in any other suitable manner.

The back end server(s) 420 may include, for example, a server providing a voice mail retrieval and notification function. This voice mail retrieval and notification function may include the capability to receive notifications when a user receives a voice mail, physically call a user's voice mail system, enter the appropriate codes to retrieve the voice mail, retrieve the voice mail, convert the voice mail to a digital file, and send it to the digital companion servers 406.

Additionally, these back end server(s) 420 may also include, for example, a directory assistance server. This directory assistance server may interface the service center 106 with a Reverse Directory Assistance Gateway (RDA Gateway) of the voice network 104. An RDA Gateway is a device for issuing requests to a Data Operations Center (DOC) of the voice network 104 for name and/or address information associated with a phone number and receiving the name and/or phone number in response to this request.

In another example, the back end server(s) 420 may include a wireless internet gateway that is used for interfacing with a mobile switching center (MSC) of a wireless voice network. As with the above-described back end server(s) 420, this wireless internet gateway may be used for converting requests and information between the formats used by the service center 106 and those used by the wireless voice network.

In yet another example, the back end server(s) 420 may include a conference blasting server for instructing a conference bridge in the voice network 106 to dial out via an SSP to the participants of a voice conference. Alternatively, for example, the back end server(s) may include a server for instructing an IP of the voice network to place a call between two parties by dialing out to each of the parties. The back end server(s) may also include the capability to instruct the bridge or IP device to call an audio digitizing device that can listen to the conference, convert the audio signals to digital format, and forward the digitized signals to a user device via, for example, an audio streaming server. The audio streaming server may, for example, allow a user to connect to it via, for example, the Internet. Additionally, the audio streaming device may buffer or record the signals to permit the user to pause, rewind, and/or fast-forward thru the conference.

In yet another example, the back end server(s) 420 may include a Single Number Short Message Service (SN SMS) server for interfacing the service center 106 with a Short Message Service (SMS) gateway in the voice network 104. This may be used to permit the customer to have SMS messages addressed to their home phone number directed to an SMS capable device of the users choosing.

The voice network plane 508 includes the hardware and software included in the voice network 104, as discussed above with reference to FIG. 3. For example, the voice network plane 508 may include the ISCP SPACE 314, the ISCP 302, the intelligent peripherals 320, and the SSP 308. Additionally, the voice network plane 508 may also include the hardware and software included in a wireless carrier's network, such as, for example, the mobile switching center, etc.

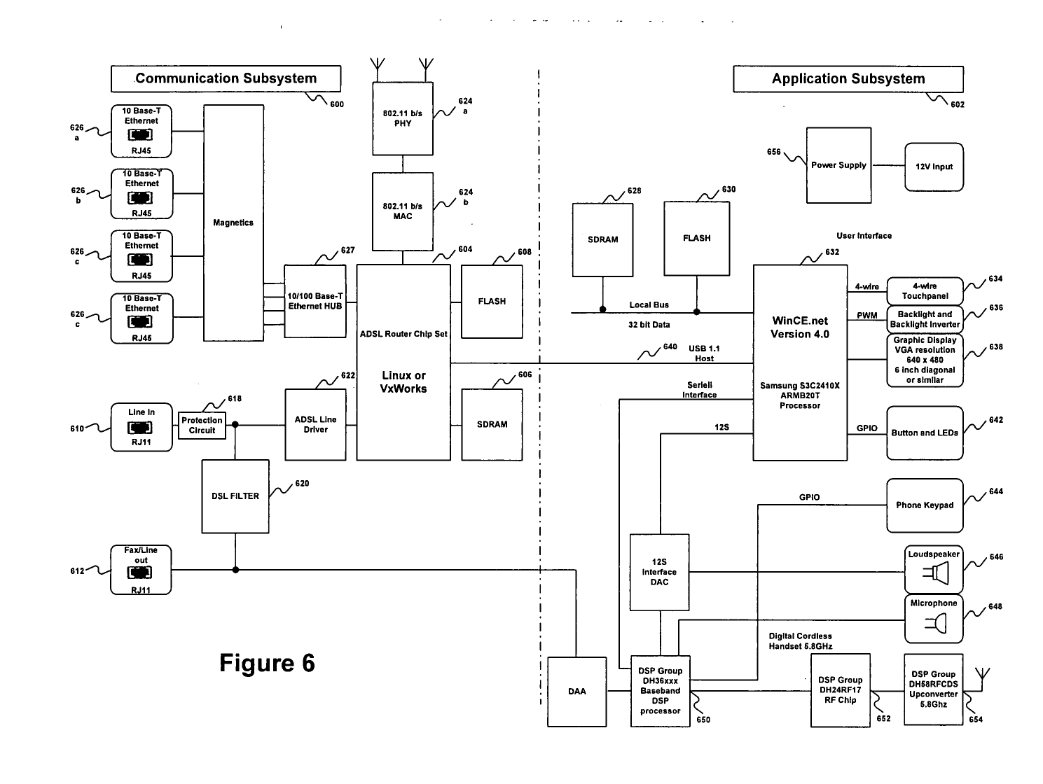

FIG. 6 illustrates another exemplary user terminal 112 consistent with the present invention. User terminal 112 of FIG. 6, for example, may be a device capable of connecting to both a data network and a voice network. User terminal 112 may include a communications subsystem 600 and an application subsystem 602. Communications Subsystem 600 may be used for running the Asymmetric Digital Subscriber Line (ADSL), modem, router/switch/Ethernet, and wireless capabilities of the user terminal 112, and the application subsystem 602 may be used for running the digital companion applications, controlling the user interface including the LCD screen and the PSTN functions. Communication subsystem 600 may include an ADSL Bridge Router 604 with an embedded 802.11 b/g access point. Communication subsystem 600 may also include SDRAM 606 that may provide storage for program data and application data. Communication subsystem 600 may also include Flash memory 608 for storage of boot firmware, Operating System, drivers, protocol stack and application programs. Moreover, communication subsystem 600 may include two RJ11 jacks. Jack (Line in) 610 may connect to a telephone outlet, while jack (Fax/Model) 612 may provide a filtered pass-thru for a fax/modem connection. Additionally, communication subsystem 600 may include a line protection circuit 618 and a Digital Subscriber Line (DSL) filter 620 that separates the analog signal from the discrete Multitone (DMT) signal for the ADSL modem. Communication subsystem 600 may also include an ADSL line Driver 622, an 802.11 b/g Access Point 624a for the professional unit and a 802.11 b/g station and 624b for the companion unit. Communication subsystem 600 may also include a four port Ethernet switch 626a, 626b, 626c, and 626d, and a 10/100 Ethernet Hub 627.

Application subsystem 602 may include SDRAM 628 that may provide storage for program data and application data. Application subsystem 602 may also include Flash memory 630 for storage of boot firmware, Operating Systems, drivers, protocol stack and application programs. Application subsystem 602 may also include a processor 632 and a touch panel 634, a backlight and backlight inverter 636, and a graphic display 638. A real time clock (not pictured) may also be built into the system CPU to provide the system with real time information. Application subsystem 602 communicates with the communications subsystem 600 via the Universal Serial Bus (USB) Host Rev 1.1 interface 640. Application subsystem 602 may also include pushbuttons, switches and LEDs (Light Emitting Diode) 642 and a phone keypad 644. Application subsystem 602 may also include a loudspeaker 646 and a microphone 648. Additionally, application subsystem 602 may include a baseband processor 650 as well as an RF interface 652 that connects to the broadband processor 650, and a RF upconverter 654. Application subsystem 602 may also include a power supply 656. One of ordinary skill in the art will appreciate that although user terminal 112 of FIG. 6 has been depicted as using specific types of hardware in a specific layout, other hardware in alternative layouts may be utilized instead.

User terminal 112 may also include a program (not pictured) that is capable of running different services. These services may include telephone services such as an address book, a super pages service, a calendar, a memo pad, and a call log. The services may also include Internet services such as a weather service, a news service, and a sports service. Other services may include a caller ID service, a name display service, a pop up alert service, a mobile alert service, a call forwarding service, a voicemail retrieval service, a real-time call management service, a text messaging service, and a directory service.

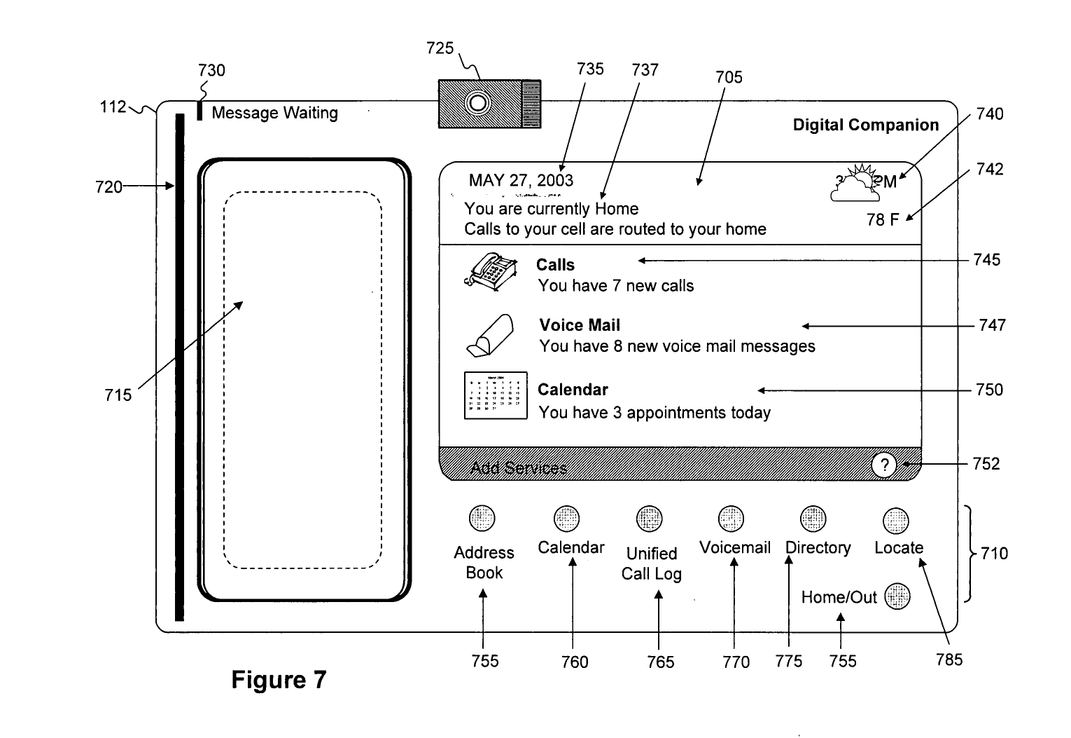

FIG. 7 illustrates exemplary features of a user terminal 112 consistent with the invention. User terminal 112 may include a touch screen or pen-based color LCD display that further includes a graphical user interface 705, multiple action buttons 710, a cordless handset 715 (one of ordinary skill in the art will appreciate that handset 715 could alternatively have a cord), a credit card scanner 720, a video camera 725, and a message-waiting indicator 730. Graphical user interface 705 may include graphical objects that may be selected via the touch screen LCD display. Such objects, for example, may include a date object 735, a status object 737, a time object 740, a weather object 742, a call log object 745, a voice mail object 747, a calendar object 750 and a help object 752. Date object 735 may indicate a current day and year. Status object 737 may indicate whether a user of user terminal 112 has specified if they are home, or away, and whether the user has forwarded calls to their cell phone to the “home” user terminal 112. Time object 740 may indicate a current time.

Weather object 742 may indicate a current temperature and, if the weather object is selected via the touch screen LCD display, may further indicate current weather conditions and, possibly, a current weather forecast, in the geographic area where the user terminal 112 is located. Call log object 745 may indicate a number of new calls made to user terminal 112 and, if selected via the touch screen LCD display, may display a unified call log that contains new calls made to the “home” user terminal and to one or more specified cell phones. Voice mail object 747 may indicate a number of new voice mail messages and, if selected via the touch screen LCD display, may display a unified voice mail list that lists new voice mails for the “home” DC phone and for specified cell phones. Calendar object 750 may indicate a number of previously entered appointments for the day indicated in date object 735. If selected via the touch screen LCD display, calendar object 750 may result in the display of a calendar for a current month upon which appointments may be viewed, entered or removed. Help object 752 may, if selected via the touch screen LCD display, lead to a help screen that may explain the various functions and operations of user terminal 112. One of ordinary skill in the art will appreciate that additional objects may be included in a graphical user interface (GUI) 705 for example, CUI 705 may include a call forwarding object that reflects whether or not a call forwarding function is on or off, and enables a user to toggle that function.

Action buttons 710 may include multiple buttons that can be selected to initiate various functions. Action buttons 710 may include an address book button 755, a calendar button 760, a unified call log button 765, a voice mail button 770, a directory button 775, a home/out button 780, and a locate button 785. Selection of address book button 755 may result in a display on graphical user interface 705 that permits the viewing, inputting and removal of addresses of individuals or entities, and their corresponding e-mail addresses. Selection of calendar button 760 may result in a display of a calendar for a current month that permits the viewing, inputting and removal of specified appointments on the calendar. Selection of unified call log button 765 may result in a display of a log of new calls made to the “home” user terminal 112 and to specified communication devices that were previously registered with user terminal 112. Selection of voice mail button 770 may result in a display of a list of new voice mails that correspond to the “home” user terminal 112 and to specified communication devices that were previously registered with user terminal 112.

Selection of directory button 775 may result in the display of a telephone directory from which a user of user terminal 112 may determine the telephone and/or address of a specified individual or entity. Selection (e.g., toggling) of home/out button 780 indicates whether the user terminal 112 user is home, and calls to the user's cell phone should be routed to the “home” DC phone, or whether the user is “out,” and calls to the “home” DC phone should be routed to another device associated with a user (e.g., a preferred device). Selection (e.g., toggling) of locate button 785 may result in the display of the geographic locations of previously registered communication devices on graphical user interface 705. Such geographic locations may be retrieved from the phone network associated with the registered communication devices.

Handset 715 may include conventional circuitry for processing audio input and output so that a handset user may engage in a conversation. Handset 715 may further include a small LCD display (not shown) that can display various functions performed by the action buttons 710 and/or graphical object user terminal 112. Credit card scanner 720 may accept information from credit cards (or different types of cards) “swiped” through the scanner. Such information may be used for making purchases over a circuit-switched connection via voice network 104 or over a packet-switched connection via data network 102. Video camera 725 may include conventional circuitry for capturing video. Message waiting indicator 730 may indicate when voice mail messages corresponding to the “home” user terminal, or registered communications devices, are available to be retrieved via user terminal 112.

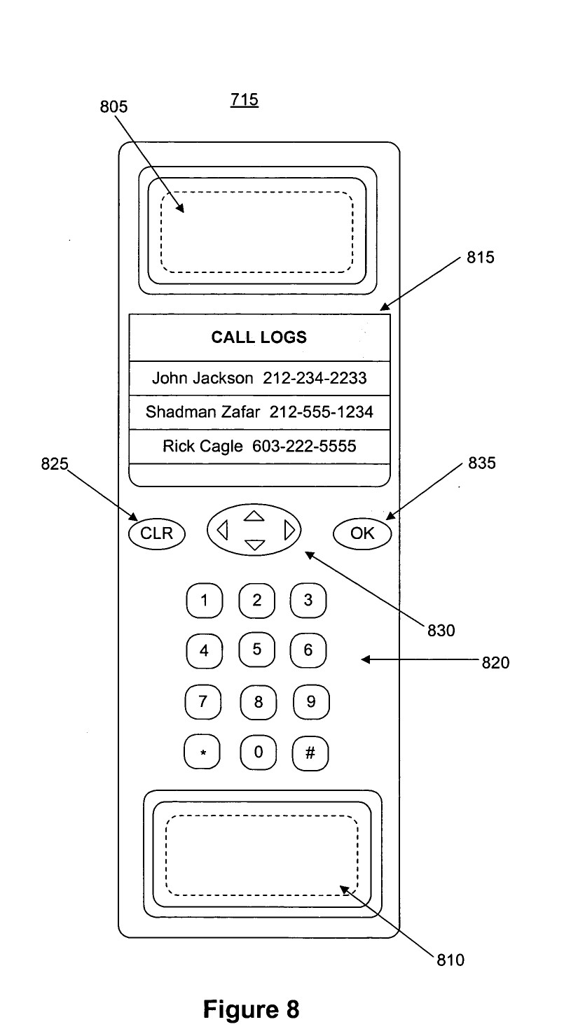

FIG. 8 illustrates an exemplary handset 715 consistent with the invention. Handset 715 may include a speaker 805, a microphone 810, a display 815, a keypad 820, a clear (CLR) button 825, a scroll button 830, and a selection button 835. Speaker 805 may include conventional mechanisms for converting electrical signals into an auditory output. Microphone 810 may include conventional mechanisms for converting an auditory input into electric signals that can be transmitted, for example, via a circuit switched connection. Display 815 may include a small LCD display that can be controlled by clear button 825, scroll button 830 and selection button 535. Keypad 820 may include conventional numbers and symbols of a telephone keypad for dialing telephone numbers. Clear button 825 may clear any current function displayed on display 815. Scroll button 830 may scroll, in a specified direction, through the current function displayed on display 815. Selection button 835 may permit the selection of individual objects displayed on display 815. For example, if a call log is displayed on display 815, scroll button 830 may be used to scroll down through a list of new calls and when, a specified call is highlighted, selection button 835 may be depressed to initiate a return call to the highlighted call in the call log.

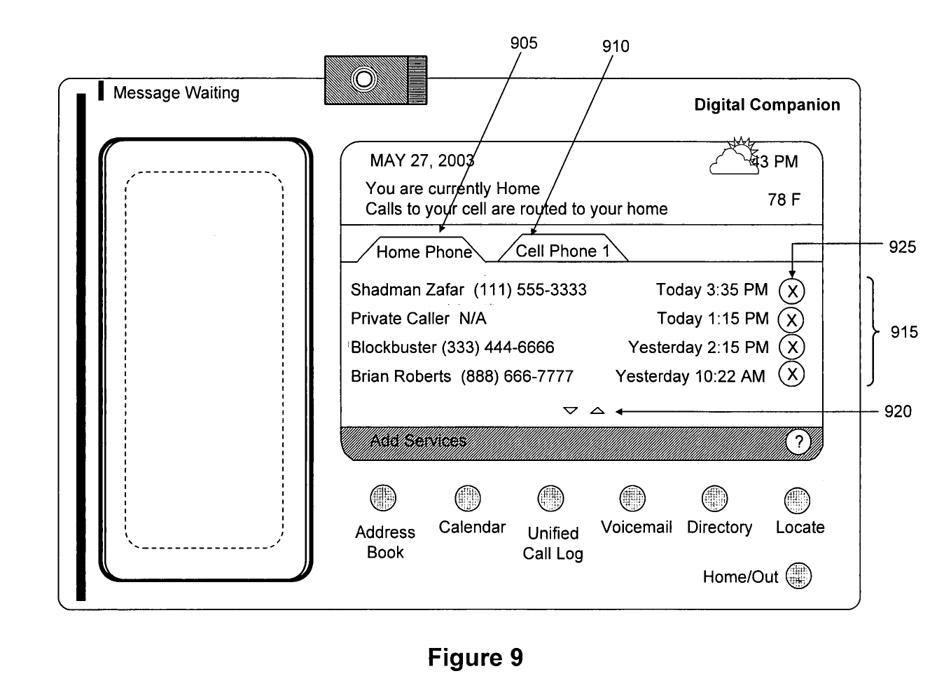

FIG. 9 illustrates the display of a “home phone” call log 905 on graphical user interface 705. “Home phone” call log 905 may include multiple entries 915 each of which includes a name, if available, a corresponding phone number, and a day and time at which the call was received. Each entry of call log 905 may also include a deletion button 925, the selection of which may delete the corresponding entry from call log 905. The multiple entries 915 of call log 905 may be scrolled through using graphical scroll control 920. A determination may then be made whether a “cell phone” call log has been selected. For example, as shown in FIG. 9, after display of the “home phone” call log 905, a cell phone call log 910 may be selected for display. FIG. 9 shows only a single cell phone call log 910. However, multiple cell phone call logs may be displayed for selection (i.e., one for each cell phone registered with user terminal 112).

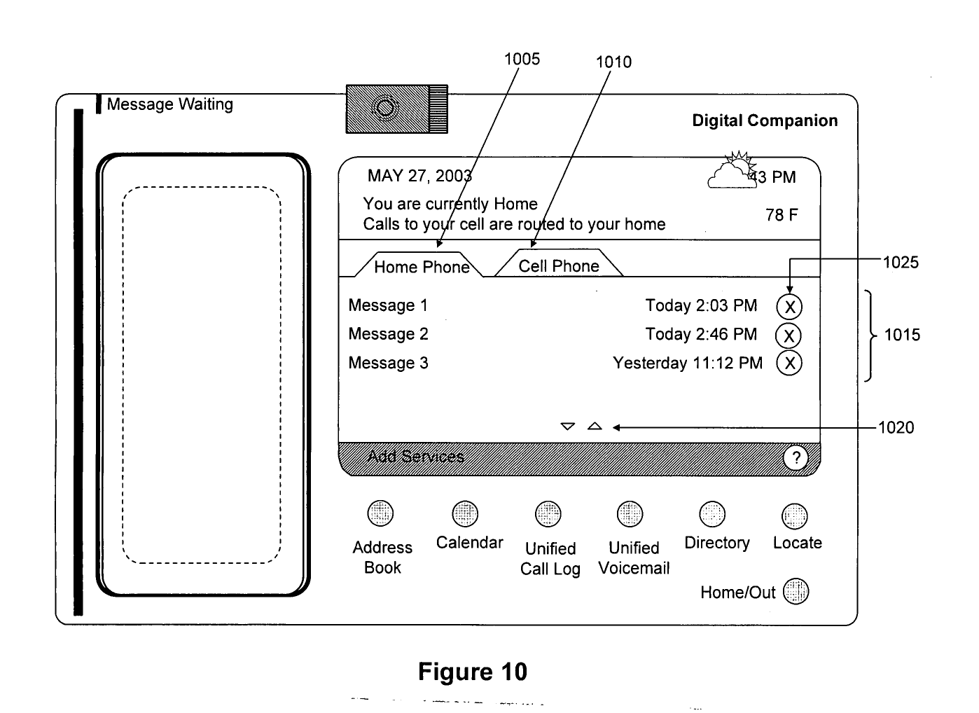

FIG. 10 illustrates the display of a “home phone” voice mail list 1005 on graphical user interface 705. “Home phone” voice mail list 1005 may include multiple entries 1015 each of which identifies a voice mail message and a day and time at which the voice mail was received. Each entry of voice mail list 1005 may also include a deletion button 1025, the selection of which may delete the corresponding entry from voice mail list 1005. The multiple entries 1015 of voice mail list 1005 may be scrolled through using graphical scroll control 1020.

A determination may then be made whether a “cell phone” voice mail list has been selected. If a “cell phone” voice mail list has been selected, then a unified “cell phone” voice mail list may be displayed. For example, as shown in FIG. 10, after display of the “home phone” voice mail list 1005, a cell phone voice mail list 1010 may be selected for display. FIG. 10 shows only a single cell phone voicemail list 1010. However, multiple cell phone voice mail lists may be displayed for selection (i.e., one for each cell phone registered with user terminal 112).

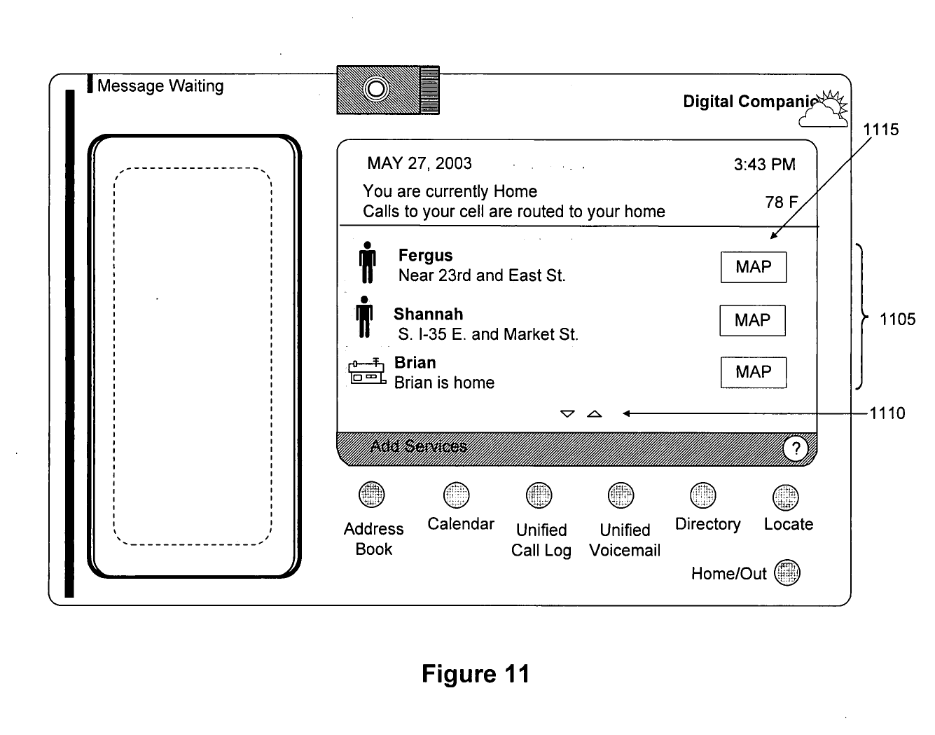

FIG. 11 illustrates the display of a list 1105 of geographic locations associated with each registered cell phone. The list 1105 may include multiple entries, each corresponding to a registered cell phone and displaying a current location of the registered cell phone.

The multiple entries of geographic location list 1105 may be scrolled through using graphical scroll control 1110. Each entry of list 1105 may include a “map” object 1115, the selection of which may result in the display of a graphical map showing the geographic location of the corresponding registered cell phone. The graphical map may be stored internally in user terminal 112, or may be retrieved from an external server via, for example, network 102.

### Call and Voice Mail Notification

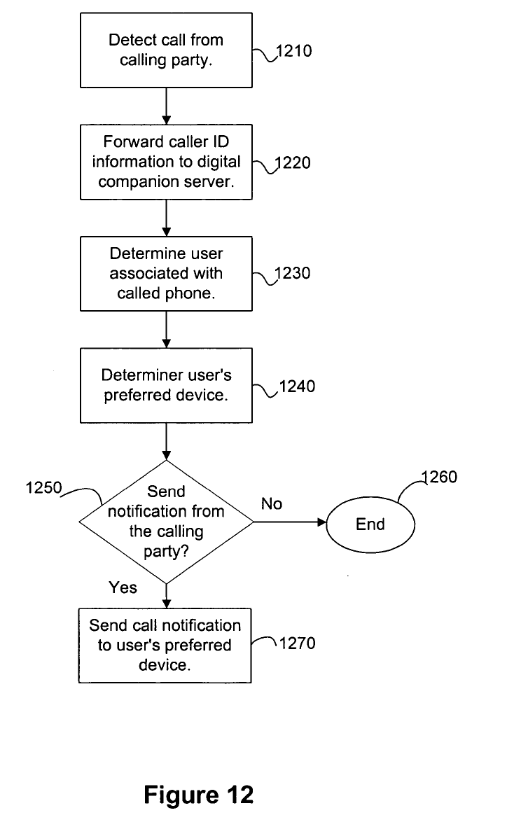

FIG. 12 is a flow diagram illustrating a method of providing a call notification over a voice and data network consistent with the present invention. Although the steps of the flowchart are described in a particular order, one skilled in the art will appreciate that these steps may be performed in a modified or different order. Further, one or more of the steps in FIG. 12 may be performed concurrently or in parallel. A switch (such as SSP 310, FIG. 5) detects and receives a call placed by a calling party 120 to a user phone, such as user phone 114, or to user terminal 112 and forwards the call to network access server 410 (step 1210). A call may be detected by configuring SSP 310 to trigger an alert to be sent to ISCP 302 whenever a call is placed to a user's phone.

After network access servers 410 receive the call (step 1210), network access server 410 may forward caller ID information from the call to digital companion server 406 (step 1220). Digital companion server 406 may initiate an application server function 516 to determine the user associated with the called phone or terminal (step 1230). Application server function 516 may next determine the user's preferred device (step 1240). Next, application server function 516 may determine whether the user has specified whether the user desires to receive call notifications from the calling party at a particular time of day or day of the week, for example (step 1250). If the user does not want to receive a call notification, the process ends (step 1260). However, if the user would like to receive notifications, then notification server 520 may send a call notification to the user's preferred device (step 1270). A preferred device may be any one of a number of devices associated with the user, including a user terminal 112. For example, if a user's preferred device is a user terminal 112 as depicted in FIG. 7, then the aforementioned call notification may be displayed on a GUI associated with the terminal. The notification may include, for example, an indication of which one of the user's devices is being called and an identification of who is calling that device (e.g. caller ID information).

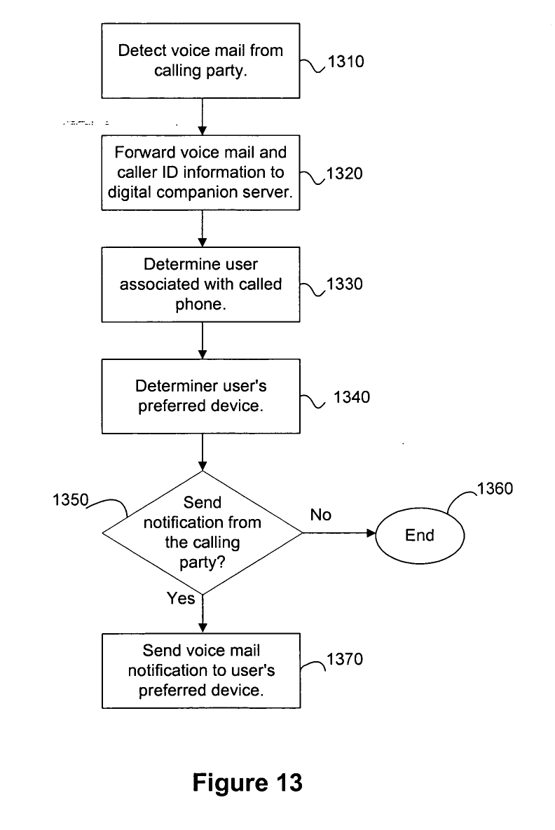

FIG. 13 is a flow diagram illustrating a method of providing a voice mail notification over a voice and data network consistent with the present invention. Although the steps of the flowchart are described in a particular order, one skilled in the art will appreciate that these steps may be performed in a modified or different order. Further, one or more of the steps in FIG. 13 may be performed concurrently or in parallel. A voice mail message is detected from a calling party (step 1310). A voice mail may be detected by configuring SSP 310 to trigger an alert to be sent to ISCP 302 whenever a voice mail is left for the user.

Back end servers 420 receive voice mail and caller ID information from the calling party over the voice network 508 and forward the voice mail and caller ID information to the digital companion server 406 (step 1320). Digital companion server 406 may initiate an application server function 516 to determine the user associated with the called phone or terminal (step 1330). Next, application server function 516 may determine the user's preferred device (step 1340). Application server function 516 may then determine whether the user has specified whether the user desires to receive voice mail notifications from the calling party at a particular time of day or day of the week, for example (step 1350). If the user does not want to receive a voice mail notification, the process ends (step 1360). However, if the user would like to receive notifications, then notification server 520 may send a voice mail notification to the user's preferred device (step 1370). For example, if a user's preferred device is a user terminal 112 as depicted in FIG. 7, then the aforementioned voice mail notification may be displayed on a GUI associated with the terminal. The notification may include, for example, an indication of which one of the user's devices is being called, an identification of who is calling that device (e.g. caller ID information), and the voicemail typed out.

### Provisioning of Communications Services

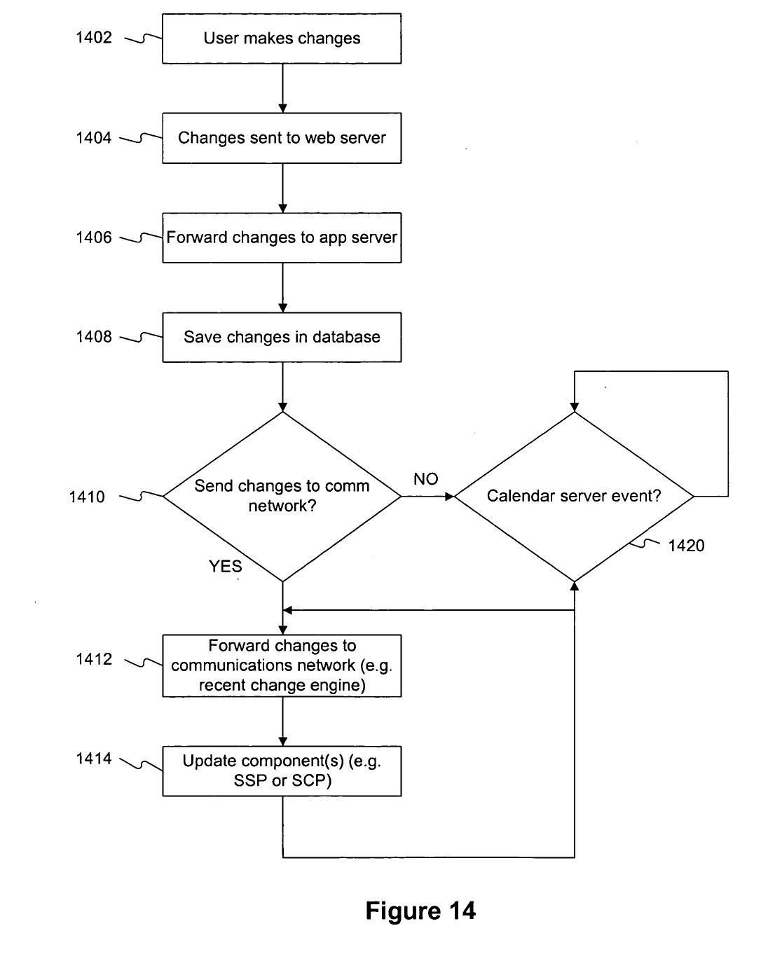

FIG. 14 illustrates a flow for chart for an exemplary method for implementing a user's selections, in accordance with methods and systems consistent with the invention. Although the steps of the flowchart are described in a particular order, one skilled in the art will appreciate that these steps may be performed in a modified or different order. Further, one or more of the steps in FIG. 14 may be performed concurrently or in parallel. A user can make changes regarding how they want calls treated (Step 1402). The user can then save the changes, such that the user's changes are forwarded to digital companion servers 406. In one embodiment, the user may make and save such changes by providing input to a user terminal 112, via a touch screen, keyboard, mouse, action buttons, or other mechanism.

In one example, user terminal 112_A executes a DC client application that may send the changes via the Internet to web server 514 of digital companion servers 406 (Step 1404). Web server 514 receives the changes and then may forward the changes to application server 516 (Step 1406). Application server 514 then may save the changes in database 522 (Step 1408).

Application server 516 may then determine whether the handling of calls to any of the user's communications lines changed and whether or not to forward any modifications to the communications network (Step 1410).

If application server 516 determines to modify the communications lines, application server 516 may forward appropriate instructions to the affected communications lines (Step 1412). For example, application server 516 may determine that a forwarding update should be sent so that all calls addressed to a particular number are to be forwarded. Then, application server 516 may forward an instruction to the appropriate component of voice network 104. For example, if application server 516 determines a forwarding update should be made, it may send an appropriate instruction to communication lines SSP 310 or ISCP 302 via its respective recent change engine 316. A further description of forwarding updates is presented below.

In an exemplary embodiment, two types of forwarding updates may be used: a Call Forward Variable (CFV) update, and an AIN update. For example, if SSP 310 (FIG. 3) servicing the communications line being modified (in this example user's home phone 114) does not support AIN services, a CFV update may be performed to implement the desired call forwarding (e.g., if SSP 310 is an older type switch not supporting AIN services.) Otherwise, an AIN update may be performed.

Accordingly, in this example, if application server 516 (FIG. 5) determines SSP 310 does not support AIN services, application server 516 performs a CFV update. Application server 516 may then send the forwarding information to the appropriate recent change engine 316 using a switch update message (Step 1412). The recent change engines 316 then updates the CFV forwarding number in user's SSP 310 (Step 1414).

In this exemplary embodiment, SSP 310 stores a table including information regarding the phone numbers supported by SSP 310. This table may also include information regarding whether the phone numbers subscribe to caller ID services, voice mail services, etc. Additionally, this table may include an entry regarding whether or not to forward calls originally directed to this phone number to a different number along with the number to which the calls are to be forwarded (i.e., the forward-to number). Accordingly, in the example, recent change engine 316 modifies the SSP's table to activate call forwarding and to insert the forward-to-number in the table. Then when SSP 310 receives calls originally directed to this phone number, it automatically forwards them to the forward-to number.

If, however, application server 516 determines that SSP 310 supports AIN services, application server 516 may transmit the forwarding information via an AIN update request message to the appropriate recent change engine 316 (Step 1412). Recent change engine 316 then updates its respective ISCP SPACE 314 (Step 1414). For example, ISCP SPACE 314 for ISCP 302 supporting SSP 310 may store information regarding how to treat calls originally directed to user's home phone 114, including whether or not calls are to be forwarded and, if so, to what number. ISCP SPACE 314 may then receive the data from recent change engine 316 and propagate local database(s) associated with ISCP 302. These databases may be, for example, internal or external to ISCP 302 and/or ISCP SPACE 314.

As discussed above, the user may also schedule a user's call forwarding treatment. For example, a user may specify that calls from a particular contact be forwarded to the user's cell phone during evenings and on weekends, and calls from the same contact be forwarded to the user's office phone during the working hours of 9 a.m. to 5 p.m. on workdays. In such an example, when the time comes for the treatment to change, the calendar server 518 may send a message to application server 516 regarding the change in call treatment (Step 1420) In response, application server 516 may then transmit the modified forwarding information to the appropriate recent change engine 316 which in turn may transmit this information to SSP 310 or ISCP SPACE, as discussed above.

After the forwarding information is provided to SSP 310 or ISP SPACE 314, calls arriving at SSP 310 for user's phone 114 are automatically forwarded to the forward-to number.

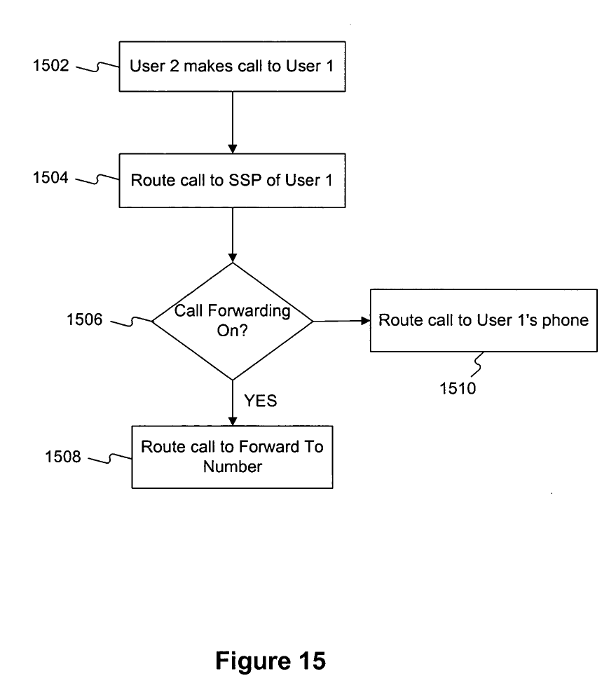

FIG. 15 illustrates a flow chart for a method for call forwarding by an SSP 310 updated via a CFV update, in accordance with methods and systems consistent with the invention. Although the steps of the flowchart are described in a particular order, one skilled in the art will appreciate that these steps may be performed in a modified or different order. Further, one or more of the steps in FIG. 15 may be performed concurrently or in parallel. As illustrated, a caller 120 (“user 2”) places a call to a DC user's (“user 1”) phone (such as phone 114), or user terminal 112 (Step 1502) The call from calling party 120 traverses voice network 104 and reaches SSP 310 servicing the user (Step 1504). SSP 310 then looks up in its table to determine if call forwarding is activated (Step 1506). If so, SSP 310 routes the call to the stored forwarding number instead of to the called number (Step 1508). If call forwarding is not activated, SSP 310 routes the call to the called number (Step 1510).

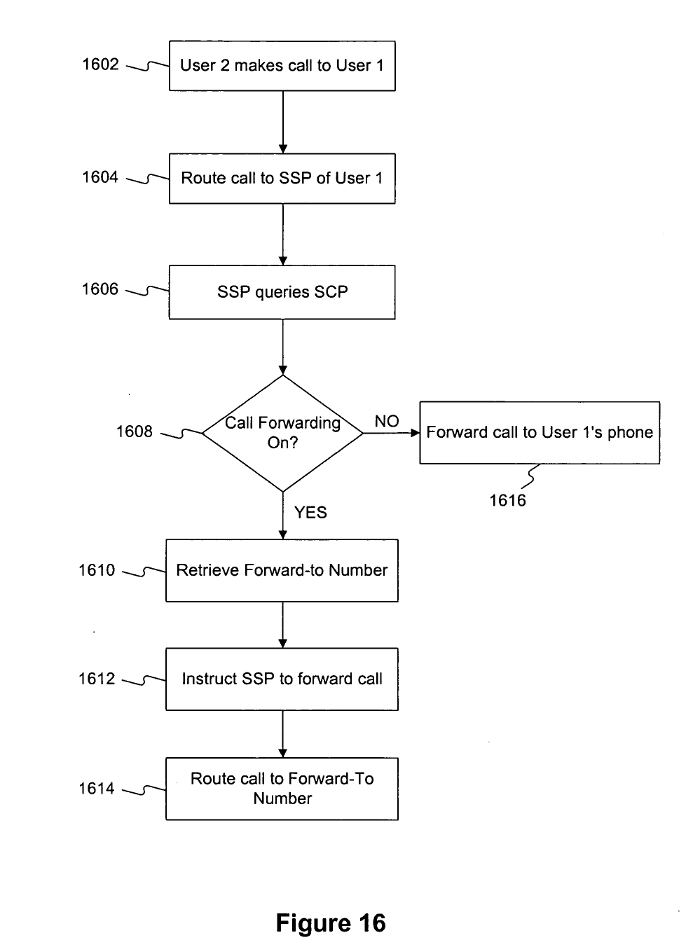

FIG. 16 illustrates a method for call forwarding, for an SSP 310 providing AIN services, in accordance with methods and systems consistent with the invention. Although the steps of the flowchart are described in a particular order, one skilled in the art will appreciate that these steps may be performed in a modified or different order. Further, one or more of the steps in FIG. 16 may be performed concurrently or in parallel. As illustrated, a caller places a call to the user's phone (such as phone 114), or to a user terminal 112 (Step 1602). The call from the calling party traverses voice network 104 and reaches the SSP 310 servicing user 1 (Step 1604). When the call reaches SSP 310, it results in an AIN trigger and SSP 310 launches a query to ISCP 302 (Step 1606). The service logic program of ISCP 302 may then look up in its database(s) whether call forwarding service is to be applied (Step 1680). If so, ISCP 302 retrieves the forwarding number from the database(s) (Step 1610). The service logic program of ISCP 302 then sends its response to SSP 310 instructing it to route to call to the forwarding number (Step 1612). In response, SSP310 forwards the call to the retrieved forwarding number (Step 1614). If, however, call forwarding is not activated for users home phone 114, ISCP 302 directs SSP 310 to forward the call to user's home phone 114 (Step 1616).

Additionally, as discussed above, a user may select to have calls treated differently based on identity of the calling party (e.g., caller-ID information) rather than simply forwarding all calls addressed to a particular communications device. If so, application server 516 of digital companion server(s) 416 may access the user's address book, calendar, etc. to create a disposition list for the device. This disposition list identifies how calls from different numbers (i.e., with different caller-IDs) are to be handled (e.g., where to forward the calls, play a message or SIT tone, etc.).

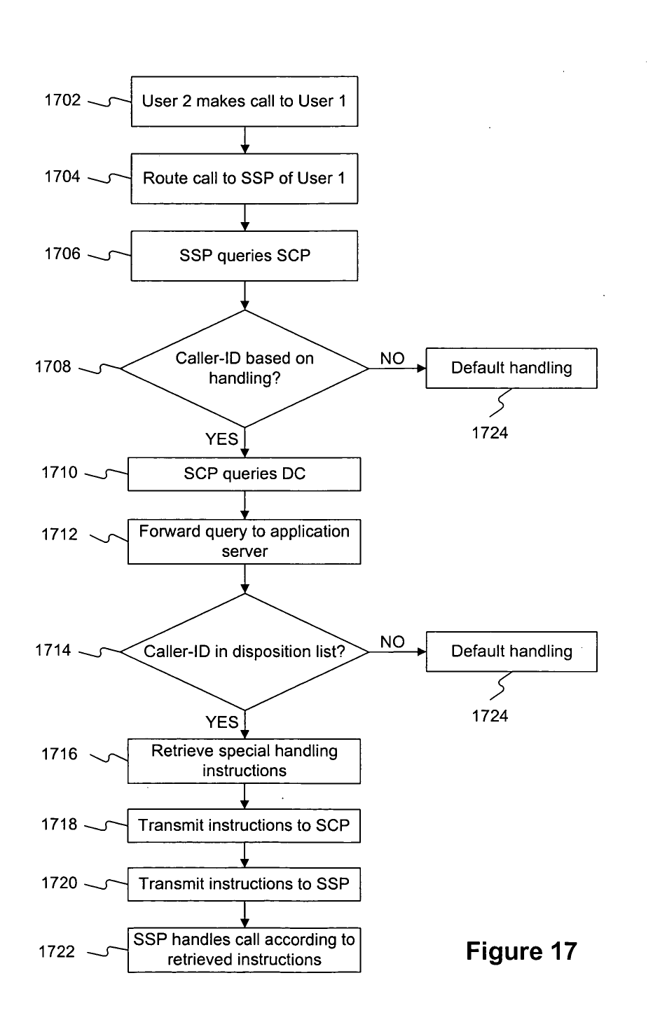

FIG. 17 illustrates a flow chart of a method for forwarding calls based on the caller-ID of the call in accordance with methods and systems consistent with the invention. Although the steps of the flowchart are described in a particular order, one skilled in the art will appreciate that these steps may be performed in a modified or different order. Further, one or more of the steps in FIG. 17 may be performed concurrently or in parallel. First, a call is placed to the user's phone (such as phone 114), or to a user terminal 112 (Step 1702). The call is then routed by network 104 to SSP 310, which is associated, for example, with user phone 114 (SSP 310 may also be associated with a user terminal 112 when terminal 112 is connected to a voice network 104) (Step 1704). SSP 310 then generates a trigger that is picked up by ISCP 302 (Step 1706). This trigger may be, for example, a Termination Attempt Trigger (TAT) or a specific Digit String (SDS). ISCP 302 then determines if special handling based on caller-ID should be applied (Step 1708). If so, ISCP 302 queries Digital Companion server(s) 406 through network access server 410 (Step 1710). This query may include the caller-ID of the calling party's phone number (i.e., “caller-ID”).

This query is then forwarded to application server 516 of digital companion 406 (Step 1712). Application server 516 then looks up the caller-ID in the disposition list (Step 1714). If the number is found in the disposition list, application server 516 retrieves from the disposition list the handling for the call (Step 1716). Application server 516 then instructs ISCP 302 to handle the call according to the retrieved handling instructions (Step 1718). ISCP 302 then instructs SSP 310 how to handle the call (Step 1720). In response, SSP 310 handles the call according to the received instructions. (Step 1722).

In a first example, the call is to be forwarded to a particular number (“forward-to number”), such as for example, to a cell phone. In such an example, application server 516 may send an instruction to forward the call to ISCP 302 via network access server 410 (Step 1718). ISCP 302 may then instruct SSP 310 to forward the call to the forward-to number, i.e. to the cell phone (Step 1720). In response, SSP 310 forwards the call to the forward-to number (Step 1722). Further, as discussed above, the user may elect to only forward the call if the called number is not answered within a user specified number of rings.

In a second example, the caller-ID may not exist in the disposition list and application server 516 may elect to apply a user specified default treatment to the call (Step 1724). For example, the user may elect for home phone 114 to ring if no specific treatment is specified. In other examples, the default may be set to forward the call to a particular number such as mobile phone or a vacation number, if, for example, the user is on vacation. In such an example, the default handling may be stored in digital companion server(s) 406 and then retrieved and forwarded by application server 516 to ISCP 302 as discussed above. Or, in another example, application server 516 may simply send an instruction to ISCP 302 to handle the call according to its default (e.g., the information stored in ISCP 302 or SSP 306 regarding handling of calls to this communications line).

In a third example, a user may select that calls from a particular caller-ID be sent directly to voice mail. In such an example, application server 516 may send an instruction to ISCP 302 forward the call to voice mail (Step 1718). ISCP 302 then may send an instruction to the SSP 310 (Step 1720). In response, SSP 310 forwards the call to an IP 320 providing voice mail services (Step 1722).

In a fourth example, the user may select that a Special Instruction Tone (SIT) cadence be played to the caller based on the caller-ID or in the event the caller-ID is unavailable. In such an example, application server 516 may send an instruction to play a SIT cadence to ISCP 302. (Step 1718). In response, ISCP 310 may direct SSP 310 to forward the call to an IP which in turn plays a SIT cadence (Step 1720). The call may then be terminated or forwarded to voice mail, etc. (Step 1722). Alternatively, rather than playing a SIT cadence, the user may direct that a particular voice recording be played to the caller based on the caller-ID.

In yet another example, the user may specify both a primary and a secondary handling procedure for calls, such that the secondary handling procedure is implemented if for example the primary handling procedure cannot be completed or some other criteria is met, such as, for example, user specified criteria. For example, the user may desire to have calls to their home phone from a particular contact ring the home phone, but if the home phone is busy or not answered within a specific number of rings then forward the call to the user's cell phone. The user may also be able to schedule these primary and secondary handling procedures.

The user may specify these primary and secondary handling procedures in a similar manner to the scheduling of a single handling procedure using screens such as those described in U.S. patent application Ser. No. 10/720,971 filed Nov. 24, 2003, which is expressly incorporated herein by reference in its entirety. In one embodiment, similar screens may be implemented on a user terminal 112 consistent with the present invention. These screens provide the user with the ability to specify both primary and secondary handling procedures. Additionally, these screens may permit the user to specify when the secondary handling procedure should be used. For example, the user may specify that the secondary handling procedure be used if the primary handling procedure cannot be completed because the line is busy or not answered in a predetermined number of rings, or, if the phone is turned off or out of range as may, for example, be the case with wireless phones.

In the example of a user specifying both a primary and secondary handling procedure, when a call arrives at the communications line, the application server 516 may determine based on the user, specified criteria, whether to apply the primary or secondary handling procedures. The application server 516 may then direct that the call be handled based on the determined procedure using methods and systems, such as those discussed above.

In another example, in addition to the user specifying that the handling procedure be based on a schedule, the user may also be capable of specifying the handling procedure based on the user's location. For example, the user may be able to specify for calls to be forwarded to their office phone if, for example, the user is logged on to the digital companion servers) via a computer in the user's office. Or, for example, the user may specify that the calls be forwarded to the user's wireless phone if for example, the user is logged on to the digital companion server(s) via a wireless device, such as, for example, their wireless phone or a PDA. Additionally, in another example, the user may have a device with Global Positioning System (GPS) type capabilities such that the user's location is forwarded to the digital companion server(s) 406. The user in such an example may then specify how to handle calls from contact(s) based upon the information regarding the user's location.

In yet another example, the above-discussed screens may include options for adding contacts from the user's address book to various lists, such as for example, a selective call acceptance list, a selective call rejection list and a selective call forwarding list. For example, if a contact is added to the selective call acceptance list and the user has selected to block calls, then the digital companion server(s) 406 may determine whether or not the caller-ID information is on the selective acceptance list and if so complete the call to the called device, and if not, send the call to voice mail. If, for example, a contact is on the selective call rejection list, then calls from the contact may be sent directly to voice regardless of whether or not the user has selected to block all calls. Additionally, if, for example, a contact is on the selective call forwarding list, then the digital companion server(s) 406 may direct that calls from this contact be forwarded to a number associated with the selective call forwarding list.

In yet another example, the user may be able to define groups of contacts such that calls from any of the contacts in the group are handled in a common manner. For example, the user, using screens similar to those discussed above, may create a group of all contacts in the user's address book that work with the user. The user may then give this group a name (e.g., co-workers) such that this group becomes a separate entity in the user's address book. The user may then, for example, select a handling procedure for this group so that any call from any member of the group is handled according to the handling procedure for the group.

### Real-Time Call Management

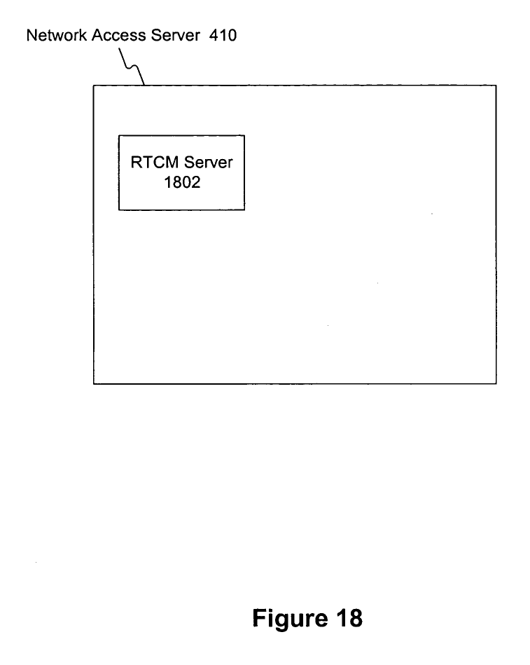

FIG. 18 shows an exemplary network access server 410 consistent with the present invention. As noted above in conjunction with FIGS. 4 and 5, network access server 410 may include functionality that enables real-time call management. Real-time call management (RTCM) server 1802 may be used to perform this functionality. For example, RTCM server 1802 may facilitate call management by receiving information indicative of an incoming call from an ISCP 302, forwarding a request related to that information to digital companion server 406, receiving a response to the request, and causing the ISCP 302 to connect the call based on the response. One of ordinary skill in the art will recognize that other functionality may also be included in a network access server 410 in addition to RTCM server 1802.

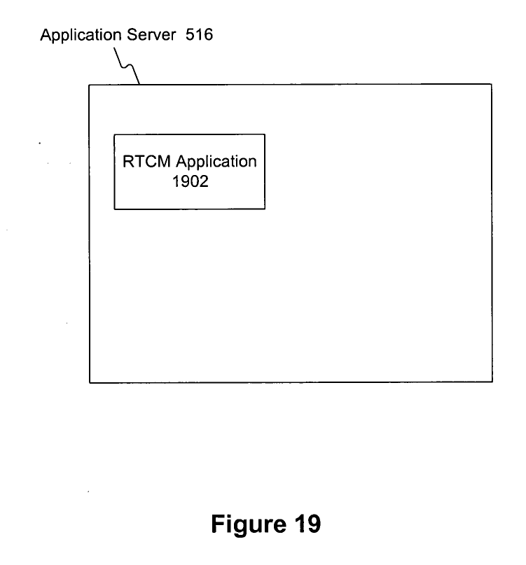

FIG. 19 shows an exemplary application server 516 consistent with the present invention. As noted above in conjunction with FIG. 5, application server 516 may include functionality that facilitates real-time call management. RTCM application 1902 may be used to perform this functionality. For example, RTCM application 1902 may facilitate call management by receiving a request corresponding to an incoming call, looking up customer-specific information, and providing information to a notification server that may notify a customer of an incoming call and present the customer with several options on handling the call. One of ordinary skill in the art will recognize that other functionality may also be included in an application server 516 in addition to RTCM application 1902. One of ordinary skill in the art will also recognize that RTCM application 1902 may be located in application server 528 instead of or in addition to application 516.

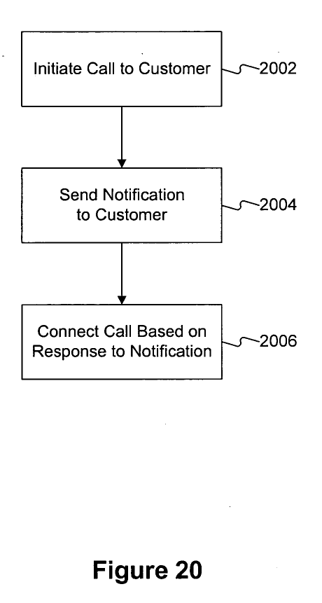

FIG. 20 is a diagram of an exemplary flowchart of a method for real-time call management in a manner consistent with the present invention. Although the steps of the flowchart are described in a particular order, one skilled in the art will appreciate that these steps may be performed in a modified or different order. Further, one or more of the steps in FIG. 20 may be performed concurrently or in parallel.

As illustrated in FIG. 20, a calling party first initiates a call to a digital companion customer (step 2002). For example, calling party 120 may use a phone, such as phone 122, to call a digital companion customer, such as user 110. In response to the initiation of a call, service center 106 may send a notification of the incoming call to the customer at a communications device (step 2004). The notification may present a number of customer-selectable options associated with it that enable the customer to manage a call in real-time. For example, the notification may present different options that permit a customer to send a call to voice mail, send a call received on one device to another device, perform a call screening operation, accept a call, play an announcement, place a call on hold, schedule a call back operation, perform an automatic call back operation, or bridge the caller onto the current call. Once the customer selects one of the call management options (e.g., by pressing an appropriate button on a touch-sensitive display), service center 106 causes the call to be connected based on the customer's response to the notification (step 2006).

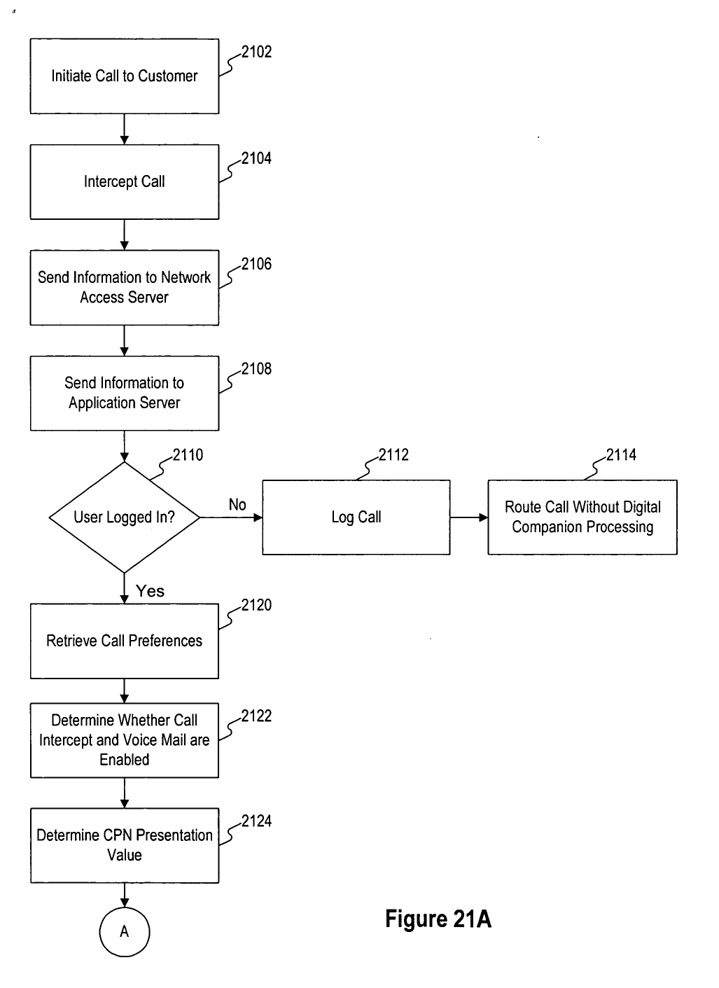

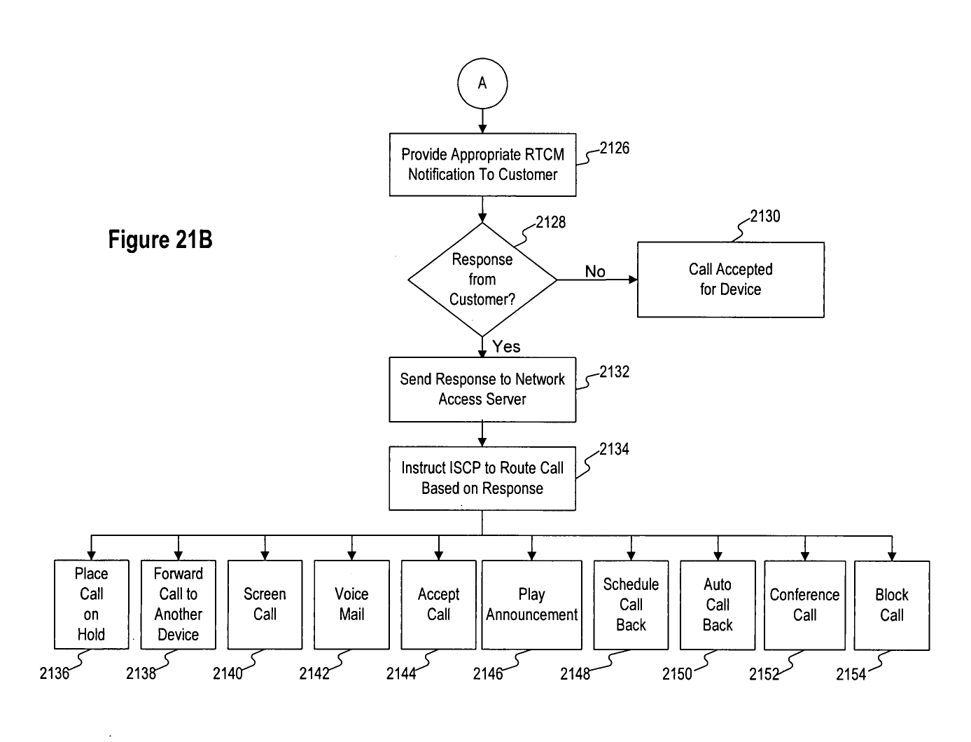

FIGS. 21A and 21B comprise an expanded diagram of an exemplary flowchart of a method for real-time call management in a manner consistent with the present invention. Although the steps of the flowchart are described in a particular order, one skilled in the art will appreciate that these steps may be performed in a modified or different order. Further, one or more of the steps in FIG. 21 may be performed concurrently or in parallel.

As illustrated in FIGS. 21A and 21B, a calling party first initiates a call to a digital companion customer (step 2102). For example, calling party 120 may use a phone, such as phone 122, to call a digital companion customer, such as user 110. In one embodiment, the call may be routed from a phone to a voice network, such as voice network 104, where an SSP 308 or 310 may intercept the call (step 2104). The SSP 308 or 310 may intercept the call because it encountered a trigger, such as a terminating attempt trigger or a specific digit string trigger, associated with the call. For example, a trigger may be set at SSP 308 or 310 on each of the lines corresponding to a digital companion customer. In this manner, a trigger is set to detect calls received at the SSP that are directed to telephone numbers of digital companion customers. In addition, triggers may be set on lines corresponding to digital companion customers that have the real-time call management feature enabled. As such, calls to telephone numbers associated with digital companion customers having real-time call management are detected by the triggers. For the purposes of this description, it is those calls that the SSP intercepts. In an alternative environment, such as a soft switch environment, functionality similar to a trigger may be utilized to intercept calls.

After intercepting the call, SSP 308 or 310 sends a query to ISCP 302 requesting further instructions. In response, ISCP 302 sends call information to a network access server 410 (step 2106). More particularly, ISCP 302 may send call information to RTCM server 602. In one embodiment, the call information may be sent to network access server 410 via a Generic Data Interface (GDI), using a message structure associated with GDI (e.g., GetData, SendData, or InvokeApp). The call information sent to RTCM server 1802 may also be sent in an encrypted form.

The call information may include, for example, call state data, a call intercept parameter, a voice mail parameter, time zone data, user ID, called number data, calling name data, calling number data, and calling party number (CPN) presentation information. One of ordinary skill in the art will appreciate that additional information may be included with the call information, or that some of the previously noted information may be omitted from the call information.

Call state data may provide the current call state based on processing (e.g., AIN processing) that has already occurred for the call. For example, some possible values for call state data may be indicative of a call being authorized for termination, a call being to a call intercept (CI) service node or IP, a call being from a Cl service node or IP, a call being a priority call from the CI service node or IP, a call having a CI error encountered on a call to a CI service node or IP, or a call being on the first leg of a click-to-dial call.

The call intercept parameter identifies when a customer has call intercept. In one embodiment, a call intercept feature allows a customer to stop invalid numbers that typically appear as “unavailable,” “private,” “anonymous,” or “out of area” on a caller ID display. The feature may tell callers that unidentified calls are not accepted and ask them to record a name. If an unidentified caller does not record a name or enter an override code, the called party's phone will not ring, thus eliminating interruptions from unidentified callers.

The voice mail parameter identifies when a subscriber has voice mail capability. Time zone data refers to the customer's time zone. Called number data refers to the number of a called device associated with the subscriber. User ID refers to a parameter that may have one of two values. If a distinctive ring feature is present, then user ID is set to a primary number value. If no such feature is present, then user ID is set to the same value as the called number. Distinctive ring, for example, may provide a customer with additional telephone numbers on a single line, with their own unique ringing pattern. A customer's primary number is the main number associated with the line.

Calling number data refers to the number of the caller. This parameter may contain such a number when it is available. In addition, the parameter may contain a calling party address when the information is made available by a previously executed AIN service. Otherwise, the calling number parameter may include some arbitrary string of digits or characters (e.g., ten zeros) when the caller ID information does or does not match a particular format.

Calling name data refers to the name of the calling party. This parameter may be retrieved, for example, by ISCP 302 from a database such as LIDB 312. It may be typically possible to retrieve the calling name when the database was populated with this data by a previously executed AIN service. If the calling name is not successfully retrieved, then the calling name parameter may include, for example, an arbitrary string of digits or characters (e.g., zeros) indicative of situations where there was no response from LIDB 312, there was an erroneous response from LIDB 312, there was no name returned from LIDB 312, the format of the caller ID is not in conformance, or the caller ID presentation is restricted.

ISCP 302 also sends an announcement to an SSP where the call is being handled. The announcement can be some kind of recording that is played for the calling party. This announcement has the effects of preventing a call timer in the SSP from expiring and giving the calling party an indication that the call is progressing. The ISCP 302 may continue to cause the announcement to be played while waiting for a response from the RTCM server 1802.

Upon receiving the call information from the ISCP 302, the RTCM server 1802 may decrypt the information, if necessary, and forward the received information to application server 516 (step 2108). For example, the RTCM server 1802 may dispatch the received call information to RTCM application 702. The RTCM application 1902 may then determine whether the customer associated with the triggered phone number (e.g., destination/dialed phone number) is logged into the digital companion system (step 2110). RTCM application 1902 makes this determination, for example, by performing a lookup in a database, such as database 522, using the called number as an index. Based on the called number, RTCM application 1902 can determine a digital companion customer ID. This digital companion customer ID may have a number of access points (e.g., user terminals 112) associated with it. RTCM application 1902 may lookup entries in database 522 that correspond to the digital companion customer ID to determine whether the customer is currently logged onto the system using any access points. For example, whenever a customer is logged onto the system using an access point, an indication of such is stored in database 522. If RTCM application 1902 finds such an indication in database 522, then it knows that the customer is logged on, and it knows which access point the customer is using.

If the customer is not logged on anywhere, then there is no way for service center 106 to communicate with the customer using digital companion operations. Instead, service center 106 logs the call (step 2112). When the customer logs in at a later time, the customer is provided with an indication that the customer was called. Calls may be logged, for example, in database 522 or in other storage on digital companion server 406 or communication portal server 408. The call may be subsequently routed without digital companion processing (e.g., call may be completed as dialed, if possible) (step 2114).

If the customer is logged on, then RTCM application 702 retrieves call preference information from a database (step 2120). In one embodiment, the database storing this call preference information may be database 522, customer profile database 532, or another database used to stored customer-related data. The call preference information may include, for example, call block lists, lists of forwarding devices or telephone numbers, voice mail preferences, lists of recordings that the customer can set as pre-recorded messages, etc.

RTCM application 1902 may also proceed to determine whether the call intercept feature and/or voice mail features are enabled for the called party by examining the call information received from the RTCM server 1802 (step 2122). RTCM application 1902 makes this determination so that it knows which options should be made available to a called party using RTCM. One of ordinary skill in the art will appreciate that the RTCM application 1902 may also check for any other feature that can be enabled and disabled (e.g., call screening). RTCM application 1902 also determines the CPN presentation value associated with the call by examining the call information received from the RTCM server 1802 (step 2124). The CPN presentation value is determined so that the calling party's CPN information can either be displayed or not displayed for the customer.

Thereafter, RTCM application 1902 may provide the collected information (e.g., call information, call preference information, and access point information) to notification server 520 and instruct notification server 520 to send an RTCM notification to the customer associated with the called number (e.g., by providing an indication of the access point that the customer is using to the notification server 520). Notification server 520 has open connections to all devices (e.g., user terminals 112) that are logged on. When notification server 520 receives information from RTCM application 1902, it uses the information to route an RTCM notification to the customer at the appropriate access point (step 2126). In one embodiment, the RTCM notification may be sent using a protocol such as HTTP (Hypertext Transfer Protocol), Java, or a similar protocol.

As noted above with reference to FIG. 20, the RTCM notification may be a notification of the incoming call to the customer. The notification may include a display having a number of customer-selectable buttons associated with it that enable the customer to manage a call in real-time. For example, the notification may have different buttons that permit a customer to send a call to voice mail, send a call received on one device to another device, perform a call screening operation, accept a call, play an announcement, place a call on hold, schedule a call back operation, perform an automatic call back operation, perform a call block operation, or bridge a caller onto the current call (e.g., initiate a conference call).

The notification may provide the customer with different options dependent on the features for which the customer is authorized and has enabled. For example, if the customer does not have call intercept enabled, then the RTCM notification will not include a user-selectable area corresponding to the telemarketer zap operation. If the customer does not have voice mail enabled, then the RTCM notification will not include a user-selectable area corresponding to voice mail. One of ordinary skill in the art will appreciate that any feature that can be enabled and disabled may be used as a basis for altering the RTCM notification (e.g., call screening, conference call, etc.).

Once it has received the RTCM notification, the customer's selected device displays the RTCM notification, including the customer-selectable buttons associated with it. The device does not yet ring. Even though the device is not yet ringing, the caller may hear on the calling device (e.g., the phone or other device used to place the call) a ringing tone or an announcement indicating that the call is proceeding. RTCM server 1802 then waits for a response from the customer (step 928). Response information may include, for example, call disposition information, forwarding number information, nature of forwarding number information, carrier access code, announcement type, and ring cadence. One of ordinary skill in the art will appreciate that additional data may be included with the response data, or that some of the previously noted data may be omitted from the response data.

Call disposition information may provide an indication of the customer's choice for how the call should be handled. For example, call disposition information may include an indication of sending a call to voice mail, sending a call received on one device to another device (e.g., call forwarding), performing a call screening operation, accepting a call, playing an announcement, placing a call on hold, scheduling a call back operation, performing an automatic call back operation, performing a call block operation, or bridging a caller onto the current call.

When a call forwarding operation is invoked, forwarding number information includes a number to which the call should be forwarded. Nature of forwarding number information identifies the nature of the call forwarding number. For example, a number may be a national number or an international number.

Carrier access code may be a sequence of digits indicative of a specific carrier when a call should be routed using the specific carrier.

Announcement type identifies an announcement that should be played to the caller. This parameter, for example, may be used when the customer selects the play announcement option.

Ring cadence may be indicative of the ring cadence value that should be applied for the call. For example, different values may be used to designate normal cadence; short, short cadence; and short, short, long cadence; or any other possible cadences.

If, after a predetermined period of time, the notification server 520 has not received a response, then the call is accepted for the device receiving the RTCM notification (step 2130). For example, after the period of time, the RTCM notification may disappear from the device's display and the device may start ringing. The customer may answer the call if he or she is available and chooses to do so. One of ordinary skill in the art will appreciate that other default actions may occur instead of allowing the call to go through. For example, a busy signal may be played, the call may be sent to voice mail, the call may be forwarded to a preferred forwarding number, an announcement may be played, etc.

If the customer responds by selecting one of the RTCM options, then the RTCM notification disappears from the display, and the RTCM server 1802 receives the response and encrypts it, if necessary (step 2132). RTCM server 1802 proceeds to instruct ISCP 302 to route the incoming call based on the response from the customer (step 2134). In one embodiment, RTCM server 1802 instructs ISCP 302 by sending ISCP 302 the response information via a connection such as a GDI link. The ISCP 302 may decrypt the response data, if necessary, and route the call based on the response. For example, the service logic associated with ISCP 302 may take different actions based on the call disposition information and other information included in the response. Exemplary call routing options include place call on hold (step 2136), forward call to another device (step 2138), screen call (step 2140), voice mail (step 2142), accept call (step 2144), play announcement (step 2146), schedule call back (step 2148), auto call back (step 2150), conference call (step 2152), and block call (step 2154).

Selecting the place call on hold option (step 2136) temporarily causes the call to be delayed until the customer is ready to speak or otherwise deal with the call. For example, when the caller is placed on hold, an announcement may be played for the caller (e.g., “The party you are trying to reach is currently on a call, but wishes to talk with you. Please stay on the line.”) The popup may remain on the screen in this case and display the time elapsed since placing the caller on hold.

If a customer decides to forward the call to another device (step 2138), then RTCM server 1802 instructs ISCP 302 to route the call to a device other than the one on which the RTCM notification was received. In one embodiment, the customer may preset the phone number of the device to which the call should be forwarded. This device may be one of a plurality of devices that are normally associated with the customer (e.g., part of a list of devices stored in a digital companion database). The device may also be a device that is not one of the customer's normal potential preferred devices, but the customer has some reason that he or she wants to receive calls on the device (e.g., the device is physically close to the customer's temporary location, etc.).

In an alternative embodiment, upon selecting the forward call option, the customer may be presented with a query asking what number the call should be forwarded to. The customer may respond to the query by entering a phone number or selecting a number from a list of predetermined numbers.

When the call screening option (step 2140) is selected, the RTCM server 602 causes a series of steps to occur for screening potential telemarketers or other unwanted callers. For example, when the RTCM notification indicates that the call is from a blocked, unavailable, or otherwise undesirable number, the customer may select the call screening option. The calling party may then be presented with an announcement requesting the calling party to leave a spoken name, a PIN (personal identification number), or a voice message. In one embodiment, the announcement may be accompanied by a Special Instruction Tone (SIT) cadence.

If the calling party leaves a name, the customer's device may then ring. The ring may be accompanied by a notification that gives the customer the option of taking the call, diverting the call to voice mail, deny the call, etc. The customer's device that rings may be preset or manually provided by the customer in response to a query. The device may also be whatever device originally received the RTCM notification. The call is routed according to the customer's selection. If the calling party enters a valid PIN, the calling party's call may be connected to the customer right away. The call screening option is more fully explained in U.S. patent application Ser. No. 10/720,938, which has already been incorporated by reference.

When the voice mail option is selected (step 2142), the RTCM server 1802 may instruct ISCP 302 to route the call to the customer's current preferred voice mail number. The preferred voice mail number may be preset or manually provided by the customer in response to a query. For example, when the customer selects the send to voice mail option, the popup (e.g., RTCM notification) goes away and the incoming call is sent to either a present voice mail box or a voice mail box provided by the customer in response to a query given to the customer after the popup went away.

When the accept call option is selected (step 2144), the RTCM server 1802 may instruct ISCP 302 to route the call to the device on which the customer received the RTCM notification. If the customer is connected to the Internet via dial-up access on the same phone line that the call is to be routed, the customer's Internet session may be immediately disconnected so that the call may be answered.

In cases where the play announcement option (step 2146) is selected, the RTCM server 1802 may instruct ISCP 302 to cause a predetermined recorded announcement to be played for the calling party. For example, the customer may wish to tell particular callers that he or she is not available, without giving them the option of leaving a voice message. One of ordinary skill in the art will recognize that other announcements may be played.

When the schedule call back option is selected (step 2148), the RTCM server 1802 may instruct ISCP 302 to cause an announcement to be played for the calling party. For example, the announcement could be “the party you are trying to reach is currently on a call but will call you back later.” The RTCM server may also cause a prompt to be presented to the customer asking for the customer to set up a callback event in the digital companion calendar. This callback event may, with the customer's approval, send an e-mail or other message to the caller showing the intended date and time of the callback, if the caller is also a digital companion customer or has an e-mail address or other device indicator (e.g., phone number of a mobile phone capable of receiving text messages) in a contacts list associated with the called customer. When the time and date of the callback occur, a call may be automatically placed from the called customer to the calling party.

When the auto call back option is selected (step 2150), the RTCM server 602 may instruct ISCP 302 to cause an announcement to be played for the calling party. For example, the announcement could be “the party you are trying to reach is currently on a call but will call you back as soon as that call is finished.” When the customer's line is free (e.g., the customer is done with the previous call), a call may be automatically placed from the customer to the calling party.

When the conference call option is selected (step 2152), the RTCM server may instruct ISCP 302 to cause the calling party to be bridged onto the current call. For example, the called customer may be on a telephone call with a first party when a second party calls the customer. If the customer selects the conference call option, the a RTCM server 1802 instructs ISCP 302 to create a conference call between the customer, the first party, and the second party. For example, in response to a request from RTCM server 602, ISCP 302 may instruct a switch handling the existing call between the customer and the first party to bridge the incoming call from the second party with the existing call. One of ordinary skill in the art will appreciate that the calling party can be bridged onto a conference call between the customer and multiple other parties instead of bridged onto a normal call between the customer and one other party.

When the block call option is selected (step 2154), the RTCM server 1802 may instruct ISCP 302 to cause a predetermined recorded announcement to be played for the calling party. For example, the announcement could be “the party you are trying to reach does not wish to speak to you.” The calling party's number may also optionally be added to a call block list of numbers with which the customer does not wish to speak.

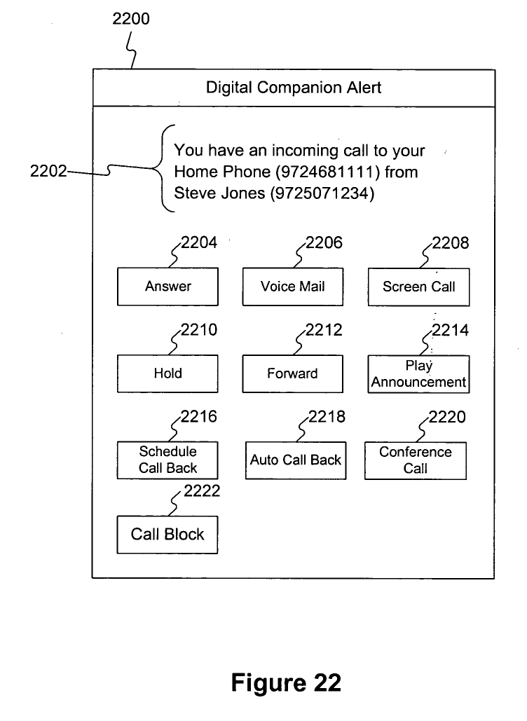

FIG. 22 is a diagram of an exemplary user interface 2200 including customer-selectable real-time call management options. User interface 2200 may be a display on a customer device, such as user terminal 112 or phone 114, that is currently showing an RTCM notification. The RTCM notification includes an area 2202 indicating that the customer has an incoming call. Area 2202 also provides an identification of the caller as well as the number being called. The number being called may belong to the device displaying the RTCM notification or another device. The RTCM has a number of user-selectable areas 2204-2222 associated with it, allowing the customer to decide how an incoming call is routed. In one embodiment, the customer may select one of these user-selectable areas through any suitable input methods. For example, the customer may click on the desired option using a mouse, touch an appropriate area of a touchscreen, enter input on a keypad, etc., in order to choose the manner in which the incoming call is routed.

Selecting area 2204 enables the customer to answer the call on the device that received the RTCM notification (e.g., the device the includes user interface 1000). Selecting area 2206 forwards the call to voice mail as discussed above with reference to FIGS. 21A and 21B. Selecting area 2208 initiates a call screening feature as discussed above with reference to FIGS. 21A and 21B. Selecting area 2210 places the call on hold as discussed above with reference to FIGS. 21A and 21B. Selecting area 2212 forwards the call to another device of the customer's choosing as discussed above with reference to FIGS. 21A and 21B. Selecting area 2214 plays an announcement for the calling party as discussed above with reference to FIGS. 21A and 21B. Selecting area 2216 enables a customer to schedule a call back event on a calendar as discussed above with reference to FIGS. 21A and 21B. Selecting area 2218 enables a customer to cause the calling party to be automatically called back after the current call as discussed above with reference to FIGS. 21A and 21B. Selecting area 2220 bridges call party onto the current call as discussed above with reference to FIGS. 21A and 21B. Selecting area 2222 cause a recording to be played indicating that the customer does not wish to speak to the calling party and optionally cause the calling party's telephone number to be added to a call block list, as discussed above with reference to FIGS. 21A and 21B.

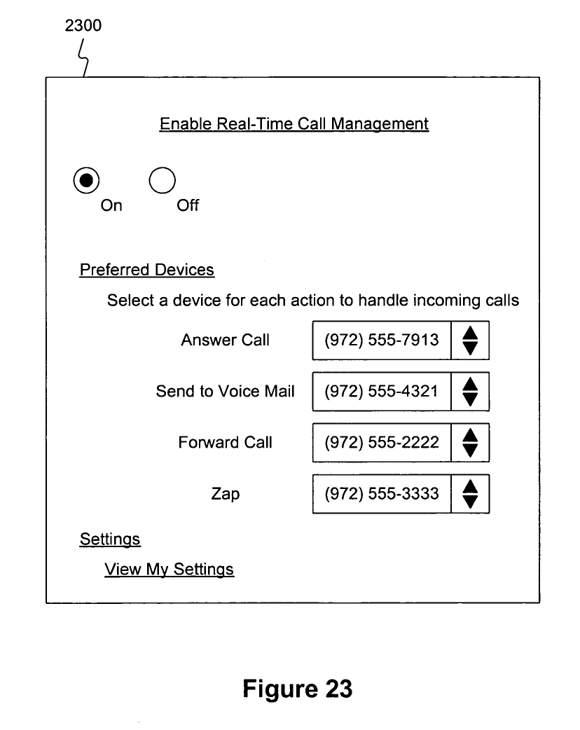

FIG. 23 is a diagram of an exemplary user interface 2300 that enables a customer to change preferences consistent with the present invention. User interface 2300 may be a display on a customer device, such as user terminal 112 or phone 114. As illustrated in FIG. 23, a customer may have the ability to enable or disable real-time call management for a given device. The customer also may select particular devices to handle different actions. For example, a customer may set specific phone numbers to handle features such as answer calls, send to voice mail, forward call, and/or telemarketer zap (e.g., call screening). One of ordinary skill in the art will appreciate that other features may also have phone numbers set for them. The customer also has the option of viewing various other settings associated with the customer, such as a list of numbers that are call blocked, call back settings, etc.

### Video Conferencing

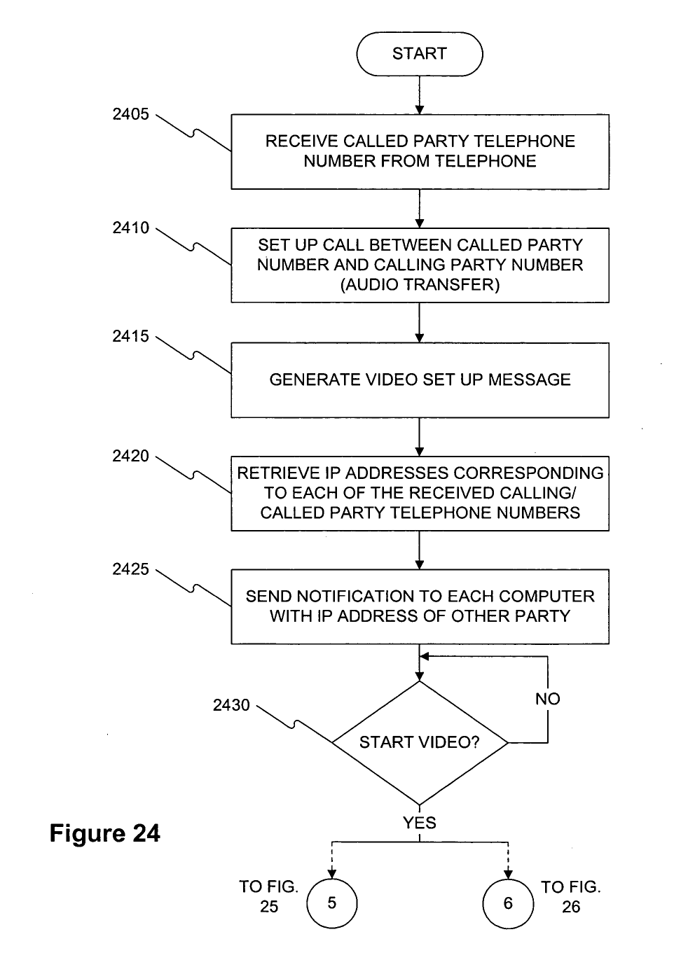

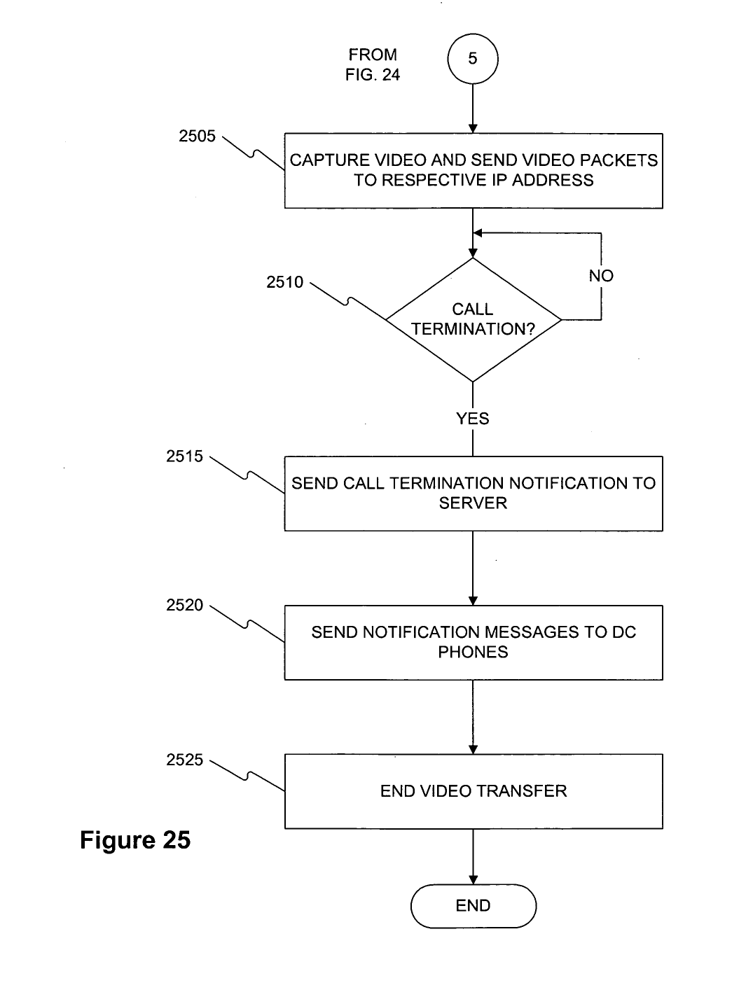

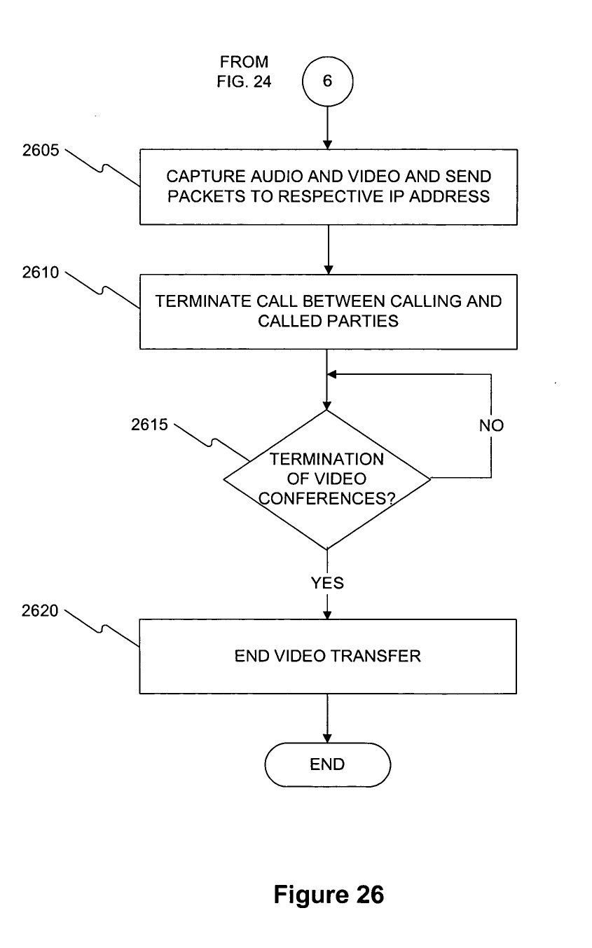

FIGS. 24-26 are flowcharts that illustrate an exemplary process, consistent with the present invention, for setting up a videoconference one or more user terminals 112. Although the steps of the flowchart are described in a particular order, one skilled in the art will appreciate that these steps may be performed in a modified or different order. Further, one or more of the steps in FIG. 24, 25, and 26 may be performed concurrently or in parallel. The videoconference may include audio transmitted via a voice network (or a data network) and video transmitted via the data network at, possibly, a DSL rate.

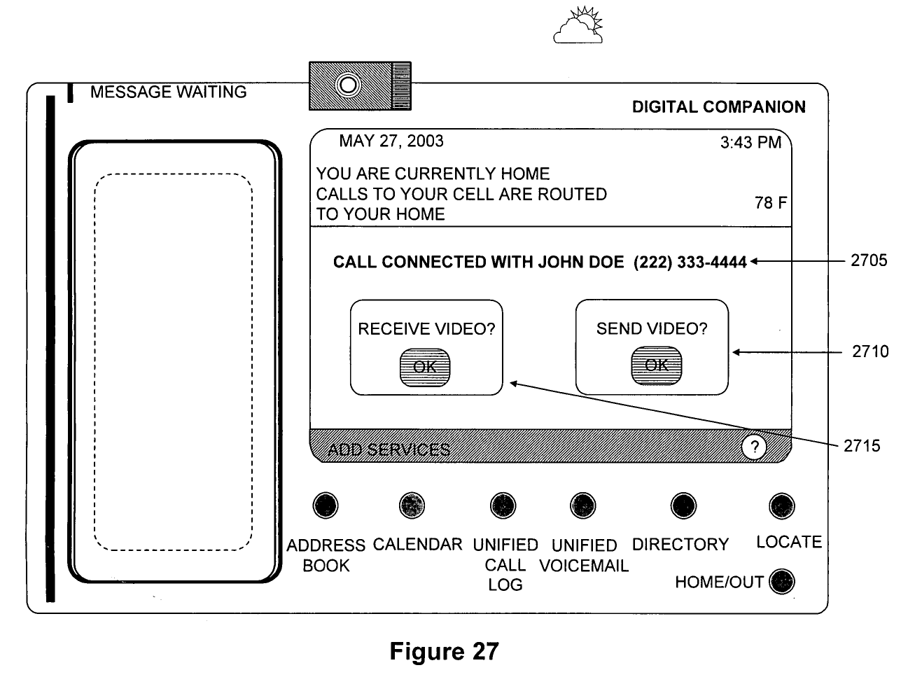

To begin the exemplary process, network access server 410 and/or ISCP 302 may receive a called party telephone number from a user terminal (e.g., user terminal 12) (Step 2405). Network access server 410 and/or ISCP 302 may set up a circuit-switched audio connection between the called party telephone number and the telephone number of the calling party (Step 2410). The telephone number of the calling party may be retrieved using, for example, conventional “caller ID.” Network access server 410 and/or ISCP 302 may further generate a video set-up message containing the called and calling party telephone numbers for use by DC server 406 (Step 2415). DC server 406 may look up network addresses corresponding to each of the received calling/called party telephone numbers (Step 2420). The network addresses identify the user terminals 112 associated with the calling and called parties. DC server 406 may then send a notification message to each user terminal 112 (i.e., the calling party's user terminal 112 and the called party's user terminal 112) with the network address (e.g., IP address) of the other party to the call (Step 2425). DC server 406 may use, for example, conventional instant messaging techniques to send the notification messages to each user terminal 112. Each user terminal 112 determines whether video transfer should be started (Step 2430). As shown in FIG. 27, after a call connection message 2705 is displayed, each party may “click” on an appropriate “OK” button in windows 2710 or 2715 of the graphical user interface, for example, to start the sending of video to the other party, or to accept the receipt of video from the other party. If video transfer is initiated, a number of different techniques may be used for transferring audio and video between the calling and called parties. In a first technique, shown in FIG. 25, audio may be sent via the voice network and video may be sent via the data network. In a second technique, shown in FIG. 26, both audio and video may be sent via the data network subsequent to call set-up over the voice network.

Turning to the technique shown in FIG. 25, each user terminal 112 may capture video, via video camera 725 (FIG. 7), and send video packets to the IP address associated with the other party (Step 2505). Network Access Server 410 and/or ISCP 302 may determine if the already established circuit-switched call between the two parties has been terminated (Step 2510). If so, Network Access Server 410 and/or ISCP 302 may send a call termination notification to DC server 406 (Step 2515). In turn, DC server 406 may send termination notification messages to the user terminals 112 engaged in the video conferencing (Step 2520). Each user terminal 112, in response to receipt of a termination notification message, may end the video transfer (Step 2525)

In the technique shown in FIG. 26, each user terminal 112 may capture video, via video camera 725 and audio, via microphone 648 of handset 715, and send audio and video packets to the IP address associated with the other party (Step 2605). After video and audio transfer is established between user terminals 112 associated with each of the calling and called parties, the already established circuit-switched call between the calling party number and the called party number may be terminated (Step 2610). For example, DC server 406 may notify Network Access Server 410 and/or ISCP 302 that the circuit-switched connection between the calling party number and the called party number may be terminated. Network Access Server 410 and/or ISCP 302 may then, accordingly, end the circuit-switched connection. Each user terminal 112 (i.e., the calling party's user terminal 112 and the called party's user terminal 112) may then determine whether audio/video transfer has been terminated by either party (Step 2615). If so, each user terminal involved in the audio and video transfer may end the transfer of the packets, containing the audio and video data, via network 418 (Step 2620).

While the present invention has been described in connection with various embodiments, many modifications will be readily apparent to those skilled in the art. One skilled in the art will also appreciate that all or part of the systems and methods consistent with the present invention may be stored on or read from computer-readable media, such as secondary storage devices, like hard disks, floppy disks, and CD-ROM; a carrier wave received from a network such as the Internet; or other forms of ROM or RAM. Accordingly, embodiments of the invention are not limited to the above described embodiments and examples, but instead is defined by the appended claims in light of their full scope of equivalents.

What is claimed is:

1. A method of providing access to integrated communications services, comprising:
receiving, from a server, a notification of incoming data at a preferred device of a user, wherein the server receives information indicating incoming data directed to one of a plurality of devices of the user other than the preferred device, and sends the notification to the preferred device, the data being in the form of one of a plurality of data types, and the notification including an identification of the type of incoming data; and
displaying the notification at the preferred device, wherein the preferred device is determined based on retrieved at a corresponding to the user, is connected to a data network, and includes a base unit, a handset, and a user interface.

2. The method of claim 1 further comprising:
sending, to the server, a user selection of, at least one of a time period during which notifications are to be transmitted to the preferred device, a device for which notifications are to be transmitted to the preferred device, and calling parties from which notifications are to be transmitted to the preferred device.

3. The method of claim 1, wherein the preferred device is connected to a circuit switched network.

4. The method of claim 3, wherein the connection to the circuit switch telephone network is established over a Public Switched Telephone Network (PSTN).

5. The method of claim 1, wherein the notification is a call notification.

5a. The method of claim 1, wherein the notification is a voice mail notification.

6. The method of claim 1, wherein the connection to the data network is established over an Internet.

7. The method of claim 1, wherein the connection over the data network is made according to Voice over IP (VOIP) protocol.

8. The method of claim 1, wherein the preferred device is capable of running different communications services.

9. The method of claim 8, wherein the services comprise at least one of telephone services, Internet services and pay for services.

10. The method of claim 9, wherein the telephone services comprise at least one of an address book, a super pages service, a calendar, a memo pad, and a call log.

11. The method of claim 9, wherein the Internet services comprise at least one of a weather service, a news service, and a sports service.

12. The method of claim 9, wherein the pay for services comprise at least one of a caller ID service, a name display service, a pop up alert service, a mobile alert service, a call forwarding service, a voicemail retrieval service, a real-time call management service, a text messaging service, and a directory service.

13. An integrated communications device comprising:
a base unit;
a handset;
a memory having a program that: receives, from a server, a notification of incoming data at a preferred device of a user, wherein the server receives information indicating incoming data directed to one of a plurality of devices of the user other than the preferred device, and sends the notification to the preferred device, the data being in the form of one of a plurality of data types, and the notification including an identification of the type of incoming data; and displays the notification at the preferred device, wherein the preferred device is determined based on retrieved at a corresponding to the user; and is connected to a data network;
a user interface; and
a processor that runs the program.

14. The device of claim 13, wherein the program further sends to the server at least one of a user selection of: a time period during which notifications are to be transmitted to the preferred device, a device for which notifications are to be transmitted to the preferred device, and calling parties from which notifications are to be transmitted to the preferred device.

15. The device of claim 13, wherein the preferred device is connected to a circuit switched telephone network.

16. The device of claim 13, wherein the connection to the circuit switch telephone network is established over a Public Switched Telephone Network (PSTN).

17. The device of claim 13, wherein the notification is a call notification.

17a. The device of claim 13, wherein the notification is a voice mail notification.

18. The device of claim 13, wherein the connection to the data network is established over an Internet.

19. The method of claim 13, wherein the connection over the data network is made according to Voice over IP (VOIP) protocol.

20. The device of claim 13, wherein the preferred device is capable of running different communications services.

21. The device of claim 20, wherein the services comprise at least one of telephone services, Internet services and pay for services.

22. The device of claim 21, wherein the telephone services comprise at least one of an address book, a super pages service, a calendar, a memo pad, and a call log.

23. The device of claim 21, wherein the Internet services comprise at least one of a weather service, a news service, and a sports service.

24. The device of claim 21, wherein the pay for services comprise at least one of a caller ID service, a name display service, a pop up alert service, a mobile alert service, a call forwarding service, a voicemail retrieval service, a call management service, a text messaging service, and a directory service.

25. A computer-readable medium containing instructions for performing a method for providing access to integrated communications services, the method comprising:
receiving, from a server, a notification of incoming data at a preferred device of a user, wherein the server receives information indicating incoming data directed to one of a plurality of devices of the user other than the preferred device, and sends the notification to the preferred device, the data being in the form of one of a plurality of data types, and the notification including an identification of the type of incoming data; and
displaying the notification at the preferred device, wherein the preferred device is determined based on retrieved at a corresponding to the user, is connected to a data network, and includes a base unit, a handset, and a user interface.

26. The computer readable-medium of claim 25, the method further comprising:
sending, to the server, a user selection of, at least one of a time period during which notifications are to be transmitted to the preferred device, a device for which notifications are to be transmitted to the preferred device, and calling parties from which notifications are to be transmitted to the preferred device.

27. The computer readable-medium of claim 25, wherein the preferred device is connected to a circuit switched telephone network.

28. The computer readable-medium of claim 25, wherein the connection to the circuit switch telephone network is established over a Public Switched Telephone Network (PSTN).

29. The computer readable-medium of claim 25, wherein the notification is a call notification.

30. The computer readable-medium of claim 25, wherein the notification is a voice mail notification.

31. The computer readable-medium of claim 25, wherein the connection to the data network is established over an Internet.

32. The computer readable-medium of claim 25, wherein the connection over the data network is made according to Voice over IP (VOIP) protocol.

33. The computer readable-medium of claim 25, wherein the preferred device is capable of running different communications services.

34. The computer readable-medium of claim 33, wherein the services comprise at least one of telephone services, Internet services and pay for services.

35. The computer readable-medium of claim 34, wherein the telephone services comprise at least one of an address book, a super pages service, a calendar, a memo pad, and a call log.

36. The computer readable-medium of claim 34, wherein the Internet services comprise at least one of a weather service, a news service, and a sports service.

37. The computer readable-medium of claim 34, wherein the pay for services comprise at least one of a caller ID service, a name display service, a pop up alert service, a mobile alert service, a call forwarding service, a voicemail retrieval service, a real-time call management service, a text messaging service, and a directory service.

38. A method for providing access to integrated communications services in a communications network comprising:
receiving, at a device, input from a user reflective of line management information regarding two or more communications lines associated with an account for the user; and
sending, from the device, to a server over a data network, the line management information, wherein the server determines that the line management information includes a modification to at least one of the communications lines associated with the account, and transmits an instruction to a component of the communications network to implement the modification to the at least one communications line,
wherein the device is connected to the data network, and includes a base unit, a handset, and a user interface.

39. The method of claim 38, wherein sending line management information comprises sending information regarding at least one of: forwarding calls originally directed to one of the communications lines to a different communications line, handling calls originally directed to one of the communications lines based on the time a call is received, and forwarding calls originally directed to one of the communications lines to one or more processors providing voice mail services.

40. The method of claim 38, wherein the device is connected to a circuit switched network.

41. The method of claim 38, wherein the connection to the circuit switch telephone network is established over a Public Switched Telephone Network (PSTN).

42. The method of claim 38, wherein the connection to the data network is established over an Internet.

43. The method of claim 39, wherein the connection over the data network is made according to Voice over IP (VOIP) protocol.

44. The method of claim 38, wherein the device is capable of running different communications services.

45. The method of claim 44, wherein the services comprise at least one of telephone services, Internet services and pay for services.

46. The method of claim 45, wherein the telephone services comprise at least one of an address book, a super pages service, a calendar, a memo pad, and a call log.

47. The method of claim 45, wherein the Internet services comprise at least one of a weather service, a news service, and a sports service.

48. The method of claim 45, wherein the pay for services comprise at least one of a caller ID service, a name display service, a pop up alert service, a mobile alert service, a call forwarding service, a voicemail retrieval service, a real-time call management service, a text messaging service, and a directory service.

49. An integrated communications device, comprising:
a base unit;
a handset;
a memory having a program that: receives, at a device, input from a user reflective of line management information regarding two or more communications lines associated with an account for the user and sends, from the device, to a server over a data network, the line management information, wherein the server determines that the line management information includes a modification to at least one of the communications lines associated with the account; and transmits an instruction to a component of the communications network to implement the modification to the at least one communications line,
wherein the device is connected to the data network;
a user interface; and
a processor that runs the program.

50. The device of claim 49, wherein sending line management information comprises sending information regarding at least one of: forwarding calls originally directed to one of the communications lines to a different communications line, handling calls originally directed to one of the communications lines based on the time a call is received, and forwarding calls originally directed to one of the communications lines to one or more processors providing voice mail services.

51. The device of claim 49, wherein the device is connected to a circuit switched network.

52. The device of claim 49, wherein the connection to the circuit switch telephone network is established over a Public Switched Telephone Network (PSTN).

53. The device of claim 49, wherein the connection to the data network is established over an Internet.

54. The method of claim 49, wherein the connection over the data network is made according to Voice over IP (VOIP) protocol.

55. The device of claim 49, wherein the device is capable of running different communications services.

56. The device of claim 55, wherein the services comprise at least one of telephone services, Internet services and pay for services.

57. The device of claim 56, wherein the telephone services comprise at least one of an address book, a super pages service, a calendar, a memo pad, and a call log.

58. The device of claim 56, wherein the Internet services comprise at least one of a weather service, a news service, and a sports service.

59. The device of claim 56, wherein the pay for services comprise at least one of a caller ID service, a name display service, a pop up alert service, a mobile alert service, a call forwarding service, a voicemail retrieval service, a real-time call management service, a text messaging service, and a directory service.

60. A computer-readable medium containing instructions for performing a method for providing access to integrated communications services in a communications network, the method comprising:
receiving, at a device, input from a user reflective of line management information regarding two or more communications lines associated with an account for the user; and
sending, from the device, to a server over a data network, the line management information, wherein the server determines that the line management information includes a modification to at least one of the communications lines associated with the account, and transmits an instruction to a component of the communications network to implement the modification to the at least one communications line,
wherein the device is connected to the data network, and includes a base unit, a handset, and a user interface.

61. The computer readable medium of claim 60 wherein sending line management information comprises sending information regarding at least one of: forwarding calls originally directed to one of the communications lines to a different communications line, handling calls originally directed to one of the communications lines based on the time a call is received, and forwarding calls originally directed to one of the communications lines to one or more processors providing voice mail services.

62. The computer readable-medium of claim 60, wherein the device is connected to a circuit switched network.

63. The computer readable-medium of claim 60, wherein the connection to the circuit switch telephone network is established over a Public Switched Telephone Network (PSTN).

64. The computer readable-medium of claim 60, wherein the connection to the data network is established over an Internet.

65. The computer readable-medium of claim 60, wherein the connection over the data network is made according to Voice over IP (VOIP) protocol.

66. The computer readable-medium of claim 60, wherein the device is capable of running different communications services.

67. The computer readable-medium of claim 66, wherein the services comprise at least one of telephone services, Internet services and pay for services.

68. The computer readable-medium of claim 67, wherein the telephone services comprise at least one of an address book, a super pages service, a calendar, a memo pad, and a call log.

69. The computer readable-medium of claim 67, wherein the Internet services comprise at least one of a weather service, a news service, and a sports service.

70. The computer readable-medium of claim 67, wherein the pay for services comprise at least one of a caller ID service, a name display service, a pop up alert service, a mobile alert service, a call forwarding service, a voicemail retrieval service, a real-time call management service, a text messaging service, and a directory service.

71. A method for providing access to integrated communications services, comprising:
receiving notification of a call to a user at a device associated with the user, the device being connected to a data network and including a base unit, a handset, and a user interface, wherein the device is determined based on retrieved data corresponding to the user, and the retrieved data was retrieved using information pertaining to the call;
receiving, at the device, input from the user indicative of a response to the notification; and
sending, to a server, response information reflective of the response to the notification, wherein the server instructs a service control point to connect the call based on the response to the notification.

72. The method of claim 71, wherein the device is connected to a circuit switched network.

73. The method of claim 71, wherein the connection to the circuit switch telephone network is established over a Public Switched Telephone Network (PSTN).

74. The method of claim 71, wherein the connection to the data network is established over an Internet.

75. The method of claim 71, wherein the connection over the data network is made according to Voice over IP (VOIP) protocol.

76. The method of claim 71, wherein the device is capable of running different communications services.

77. The method of claim 76, wherein the services comprise at least one of telephone services, Internet services and pay for services.

78. The method of claim 77, wherein the telephone services comprise at least one of an address book, a super pages service, a calendar, a memo pad, and a call log.

79. The method of claim 77, wherein the Internet services comprise at least one of a weather service, a news service, and a sports service.

80. The method of claim 77, wherein the pay for services comprise at least one of a caller ID service, a name display service, a pop up alert service, a mobile alert service, a call forwarding service, a voicemail retrieval service, a real-time call management service, a text messaging service, and a directory service.

81. The method of claim 71, wherein the notification comprises a plurality of user-selectable call disposition options.

82. The method of claim 81, wherein the call disposition options comprise at least one of sending a call to voice mail, forwarding a call to another device, performing a call screening operation, accepting a call, playing an announcement, placing a call on hold, scheduling a call back operation, performing an automatic call back operation, performing a call block operation, and initiating a conference call.

83. An integrated communications device for use in managing a call in real-time based on input from a user, comprising:
a base unit;
a handset;
a memory having a program that: receives notification of a call to a user at a device associated with the user, the device being connected to a data network, wherein the device is determined based on retrieved data corresponding to the user, and the retrieved data was retrieved using information pertaining to the call, receives, at the device, input from the user indicative of a response to the notification; and sends, to a server, response information reflective of the response to the notification, wherein the server instructs a service control point to connect the call based on the response to the notification;
a user interface; and
a processor that runs the program.

84. The device of claim 83, wherein the device is connected to a circuit switched network.

85. The device of claim 83, wherein the connection to the circuit switch telephone network is established over a Public Switched Telephone Network (PSTN).

86. The device of claim 83, wherein the connection to the data network is established over an Internet.

87. The method of claim 83, wherein the connection over the data network is made according to Voice over IP (VOIP) protocol.

88. The device of claim 83, wherein the device is capable of running different communications services.

89. The device of claim 88, wherein the services comprise at least one of telephone services, Internet services and pay for services.

90. The device of claim 89, wherein the telephone services comprise at least one of an address book, a super pages service, a calendar, a memo pad, and a call log.

91. The device of claim 89, wherein the Internet services comprise at least one of a weather service, a news service, and a sports service.

92. The device of claim 89, wherein the pay for services comprise at least one of a caller ID service, a name display service, a pop up alert service, a mobile alert service, a call forwarding service, a voicemail retrieval service, a real-time call management service, a text messaging service, and a directory service.

93. The device of claim 83 wherein the notification comprises a plurality of user-selectable call disposition options.

94. The device of claim 93, wherein the call disposition options comprise at least one of sending a call to voice mail, forwarding a call to another device, performing a call screening operation, accepting a call, playing an announcement, placing a call on hold, scheduling a call back operation, performing an automatic call back operation, performing a call block operation, and initiating a conference call.

95. A computer-readable medium containing instructions for providing access to integrated communications services, comprising:
receiving notification of a call to a user at a device associated with the user, the device being connected to a data network and including a base unit, a handset, and a user interface, wherein the device is determined based on retrieved data corresponding to the user, and the retrieved data was retrieved using information pertaining to the call;
receiving, at the device, input from the user indicative of a response to the notification; and
sending, to a server, response information reflective of the response to the notification, wherein the server instructs a service control point to connect the call based on the response to the notification.

96. The computer readable-medium of claim 95, wherein the device is connected to a circuit switched network.

97. The computer readable-medium of claim 95, wherein the connection to the circuit switch telephone network is established over a Public Switched Telephone Network (PSTN).

98. The computer readable-medium of claim 95, wherein the connection to the data network is established over an Internet.

99. The computer readable-medium of claim 95, wherein the connection over the data network is made according to Voice over IP (VOIP) protocol.

100. The computer readable-medium of claim 95, wherein the device is capable of running different communications services.

101. The computer readable-medium of claim 100, wherein the services comprise at least one of telephone services, Internet services and pay for services.

102. The computer readable-medium of claim 101, wherein the telephone services comprise at least one of an address book, a super pages service, a calendar, a memo pad, and a call log.

103. The computer readable-medium of claim 101, wherein the Internet services comprise at least one of a weather service, a news service, and a sports service.

104. The computer readable-medium of claim 101, wherein the pay for services comprise at least one of a caller ID service, a name display service, a pop up alert service, a mobile alert service, a call forwarding service, a voicemail retrieval service, a real-time call management service, a text messaging service, and a directory service.

105. The computer readable-medium of claim 95, wherein the notification comprises a plurality of user-selectable call disposition options.

106. The computer readable-medium of claim 105, wherein the call disposition options comprise at least one of sending a call to voice mail, forwarding a call to another device, performing a call screening operation, accepting a call, playing an announcement, placing a call on hold, scheduling a call back operation, performing an automatic call back operation, performing a call block operation, and initiating a conference call.

107. A method for providing access to integrated communications services, comprising:
capturing audio contemporaneously with video at a first telephone;
transmitting the captured audio, via a circuit-switched connection, from the first telephone to a second telephone; and
transmitting the captured video, via a packet-switched connection, from the first telephone to the second telephone.

108. A system for providing access to integrated communications services, comprising:
a first telephone configured to:
capture audio at a first location, and
capture video, contemporaneously with the captured audio, at the first location; and
a second telephone configured to:
capture audio at a second location, and
capture video, contemporaneously with the captured audio, at the second location,
wherein the first telephone is further configured to transmit the captured audio between the first location and the second location via a circuit-switched network and to transmit the captured video between the first and second location via a packet-switched network,
and wherein the second telephone is further configured to transmit the captured audio between the second location and the first location via the circuit-switched network and to transmit the captured video between the second and first location via the packet-switched network.

109. A computer-readable medium containing instructions for controlling at least one processor to perform a method of providing access to integrated communications services, comprising:
capturing audio contemporaneously with video at a first telephone;
initiating transmission of the captured audio, via a circuit-switched connection, from the first telephone to a second telephone; and
initiating transmission of the captured video, via a packet-switched connection, from the first telephone to the second telephone.

110. An apparatus for providing access to integrated communications services, comprising:
means for receiving, from a server, a notification of incoming data at a preferred device of a user, wherein the server receives information indicating incoming data directed to one of a plurality of devices of the user other than the preferred device, and sends the notification to the preferred device, the data being in the form of one of a plurality of data types, and the notification including an identification of the type of incoming data; and
means for displaying the notification at the preferred device, wherein the preferred device is determined based on retrieved at a corresponding to the user, is connected to a data network, and includes a base unit, a handset, and a user interface.

111. An apparatus for providing access to integrated communications services in a communications network comprising:
means for receiving, at a device, input from a user reflective of line management information regarding two or more communications lines associated with an account for the user; and
means for sending, from the device, to a server over a data network, the line management information, wherein the server determines that the line management information includes a modification to at least one of the communications lines associated with the account, and transmits an instruction to a component of the communications network to implement the modification to the at least one communications line,
wherein the device is connected to the data network, and includes a base unit, a handset, and a user interface.

112. An apparatus for providing access to integrated communications services, comprising:
means for receiving notification of a call to a user at a device associated with the user, the device being connected to a data network and including a base unit, a handset, and a user interface, wherein the device is determined based on retrieved data corresponding to the user, and the retrieved data was retrieved using information pertaining to the call;
means for receiving, at the device, input from the user indicative of a response to the notification; and
means for sending, to a server, response information reflective of the response to the notification, wherein the server instructs a service control point to connect the call based on the response to the notification.

113. An apparatus for providing access to integrated communications services, comprising:
means for capturing audio contemporaneously with video at a first telephone;
means for transmitting the captured audio, via a circuit-switched connection, from the first telephone to a second telephone; and
means for transmitting the captured video, via a packet-switched connection, from the first telephone to the second telephone.
